(19) United States
(12) Patent Application Publication
(10) Pub. No.: US 2022/0014946 A1
(43) Pub. Date: Jan. 13, 2022

(54) METHODS AND APPARATUS FOR DIGITAL TWIN AIDED RESILIENCY

(71) Applicant: Intel Corporation, Santa Clara, CA (US)

(72) Inventors: Arvind Merwaday, Hillsboro, OR (US); Kathiravetpillai Sivanesan, Portland, OR (US); Satish Jha, Portland, OR (US); Vesh Raj Sharma Banjade, Portland, OR (US); Suman Sehra, Folsom, CA (US); S M Iftekharul Alam, Hillsboro, OR (US); Leonardo Gomes Baltar, Muenchen (DE); Kuilin Clark Chen, Portland, OR (US)

(21) Appl. No.: 17/448,689

(22) Filed: Sep. 23, 2021

(51) Int. Cl. H04W 24/04; G06N 5/04; H04W 36/16; H04W 76/19; H04W 76/15

(52) U.S. Cl. CPC H04W 24/04; G06N 5/04; H04W 76/15; H04W 76/19; H04W 36/165

(57) ABSTRACT

Methods, apparatus, systems, and articles of manufacture for digital twin aided resiliency are disclosed. An example method includes accessing operational statistics corresponding to one or more physical entities, the one or more physical entities including user equipment and network equipment; updating one or more virtual entities within a virtual environment that correspond, respectively, to the one or more physical entities with the operational statistics; simulating a change to the virtual environment based on the operational statistics; generating a recommendation for the network equipment to perform a task based on the simulated change; and in response to determining a confidence of the recommendation meets a threshold confidence, provide the recommendation to the network equipment.

### FIELD OF THE DISCLOSURE

This disclosure relates generally to digital twins and, more particularly, to methods and apparatus for digital twin aided resiliency.

### BACKGROUND

Next generation wireless networks are expected to support diverse and advanced applications that involve smart cities, electrical grid, autonomous vehicles, etc., which demand greater reliability, lower latency, and higher speed wireless connectivity. Resiliency is an important characteristic of next generation wireless networks that is crucial for meeting application requirements. Resilient networks should be capable of overcoming factors that may cause disruptions in service (e.g., channel variations, user mobility, interference, etc.), to maximize availability and reliability of the wireless links. Over past few decades, wireless networks have evolved significantly to overcome these issues via advanced wireless signal processing techniques, frame structure, protocol design, multi-RAT dual connectivity capability, etc. However, current techniques do not tend to satisfy the requirements of next generation applications.

### BRIEF DESCRIPTION OF THE DRAWINGS

FIG. 1 illustrates an overview of an Edge cloud configuration for Edge computing.

FIG. 2 illustrates operational layers among endpoints, an Edge cloud, and cloud computing environments.

FIG. 3 illustrates an example approach for networking and services in an Edge computing system.

FIG. 4 illustrates a compute and communication use case involving mobile access to applications in an Edge computing system.

FIG. 5 illustrates an example mobile Edge system reference architecture, arranged according to an ETSI Multi-Access Edge Computing (MEC) specification.

FIG. 6 illustrates an example MEC service architecture.

FIG. 7A provides an overview of example components for compute deployed at a compute node in an Edge computing system.

FIG. 7B provides a further overview of example components within a computing device in an Edge computing system.

FIG. 8 is a block diagram illustrating an example architecture implemented in accordance with the teachings of this disclosure.

FIG. 9 is a block diagram illustrating relationships between functional entities within the MEC system of FIG. 8, and a dataflow between those entities.

FIG. 10 is a block diagram of an example implementation of the example digital twin circuitry of FIGS. 8 and/or 9.

FIG. 11 is a flowchart representative of example machine readable instructions and/or example operations that may be executed and/or instantiated by processor circuitry to generate a recommendation.

FIG. 12 is a flowchart representative of example machine readable instructions and/or example operations that may be executed and/or instantiated by processor circuitry to perform a handoff in response to a recommendation.

FIG. 13 is a communication diagram illustrating proactive mobility management to reduce handover failures.

FIG. 14 is a communication diagram illustrating proactive mobility management using a conditional handover recommendation.

FIG. 15 is a communication diagram illustrating use of the digital twin circuitry for intelligent beam management.

FIG. 16 is an example communication diagram illustrating the use of the digital twin circuitry for beam management.

FIG. 17 is an example communication diagram illustrating the use of the digital twin circuitry for application mobility.

FIG. 18 is a block diagram of an example processing platform including processor circuitry structured to execute the example machine readable instructions of FIG. 11 to implement the example digital twin circuitry of FIG. 8.

FIG. 19 is a block diagram of an example implementation of the processor circuitry of FIG. 18.

FIG. 20 is a block diagram of another example implementation of the processor circuitry of FIG. 18.

FIG. 21 is a block diagram of an example software distribution platform (e.g., one or more servers) to distribute software (e.g., software corresponding to the example machine readable instructions of FIG. 11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

With the advent of Edge computing, the next generation wireless networks feature the availability of powerful computing resources close to or within a wireless access network. Recent research around Edge computing has focused on providing low-latency and/or bandwidth hungry services to the users. However, techniques to improve resiliency of a wireless network (against natural/human-induced disruptions like user mobility, signal interference, channel blockage, etc.) by utilizing the Edge computing resources have not been explored.

Digital Twin (DT) is an emerging technology and is a key enabler for a range of advanced applications. For example, in intelligent transportation systems, DT can enable a range of safety and traffic efficiency related applications. As such, DT technology can be deployed in Multi-access Edge Computing (MEC) systems alongside the next generation wireless networks. In examples disclosed herein, techniques are disclosed that apply DT technology to improve the resiliency of wireless networks. In general, the DT can be applied at different layers of a wireless protocol stack to improve its resiliency features. DT-based techniques may include, but are not limited to, proactive mobility management to minimize handover failures (HOFs) and radio link failures (RLFs), robust and intelligent beam management in above 6 GHz bands (e.g., mmWave) to mitigate the undesired effects of a physical blockage, expedited application mobility in MEC systems to minimize service interruptions to the users, pre-emptive load balancing between different cells, etc.

In state-of-the-art network designs (5G, LTE, etc.), handover and/or handoff (HO) decisions for user equipment (UEs) are taken mainly based on channel measurements (received signal strength, signal-to-interference-plus-noise-ratio, etc.) reported by the UEs. There are certain chances of handover failures (HOFs) and ping-pong effects due to unforeseen scenarios, especially for high speed UEs. For example, when a high-speed UE abruptly changes from line of sight (LoS) to no line of sight (NLoS) due to a physical obstruction (e.g., a building). These issues impact the resiliency of network.

For above-6 GHz bands, 3GPP has defined procedures for the detection of beam failure at UE, and beam failure recovery (BFR) procedure through which the UE attempts to reestablish connection to the same cell via an alternative beam. This process can take several 10's of ms, and in some scenarios the alternative beams may also be affected resulting in further delays in beam failure recovery process due to multiple attempts. As such, the success of such a procedure is not guaranteed. Upon failure of the recovery process, the UE will be forced to initiate a radio link failure (RLF) procedure and cell reselection, which will induce significant duration of interruption in communication.

An API based framework for application mobility service (AMS) may be used, in which the application relocation and context transfer can be performed via MEC platform managers (MEPMs), and MEC orchestrator (MEO). Therein, the trigger for application mobility is based on the information of UE movement to a new serving cell provided by network functions like network exposure function (NEF), and radio network information (RNI) service. In such a design, the application mobility would always be delayed behind the user's mobility since the application relocation takes some time to complete. This may result in delays and/or interruptions in services provided to the mobile users.

In examples disclosed herein, techniques are disclosed in which DT techniques are used to aid in mobility management and resiliency of a network. As noted above, such DT techniques may include, but are not limited to, proactive mobility management to minimize handover failures (HOFs) and radio link failures (RLFs), robust and intelligent beam management in above 6 GHz bands (e.g., mmWave) to mitigate the undesired effects of a physical blockage, expedited application mobility in MEC systems to minimize service interruptions to the users, pre-emptive load balancing between different cells, etc. While such examples are disclosed herein, the use of DT techniques are generic and can be applied to different types of wireless networks like 5G and beyond, LTE, etc. However, the implementations in such scenarios may be different (e.g., depending on the network type). Examples disclosed herein are explained in the context of a 5G wireless network, but may be equally applicable to any other past, present, and/or future network technologies.

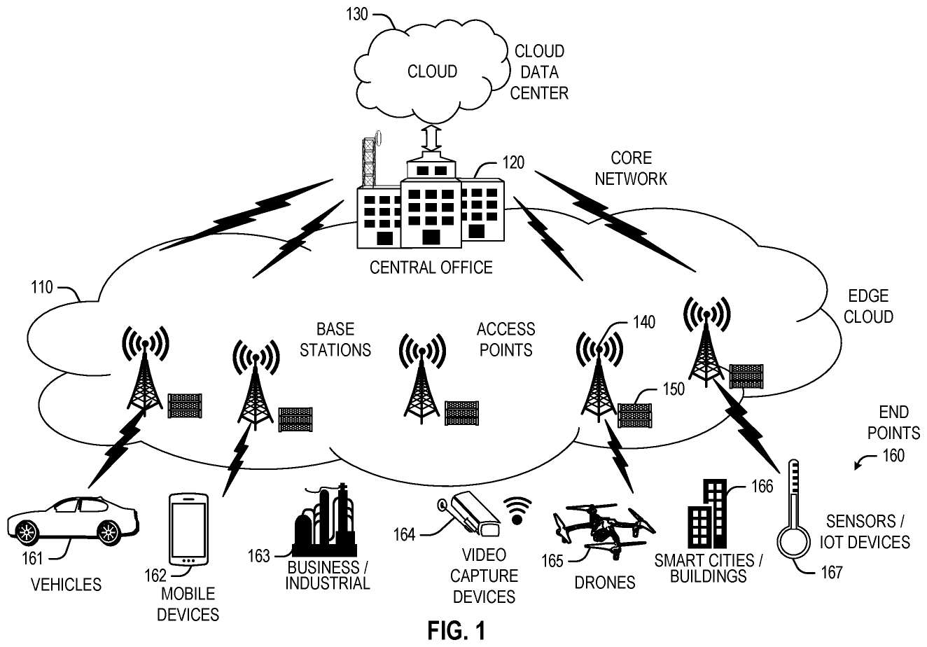

FIG. 1 is a block diagram 100 showing an overview of a configuration for Edge computing, which includes a layer of processing referred to in many of the following examples as an “Edge cloud”. As shown, the Edge cloud 110 is co-located at an Edge location, such as an access point or base station 140, a local processing hub 150, or a central office 120, and thus may include multiple entities, devices, and equipment instances. The Edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the Edge cloud 110 are critical to providing ultra-low latency response times for services and functions used by the endpoint data sources 160 as well as reduce network backhaul traffic from the Edge cloud 110 toward cloud data center 130 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate, or, bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge”, “close Edge”, “local Edge”, “middle Edge”, or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

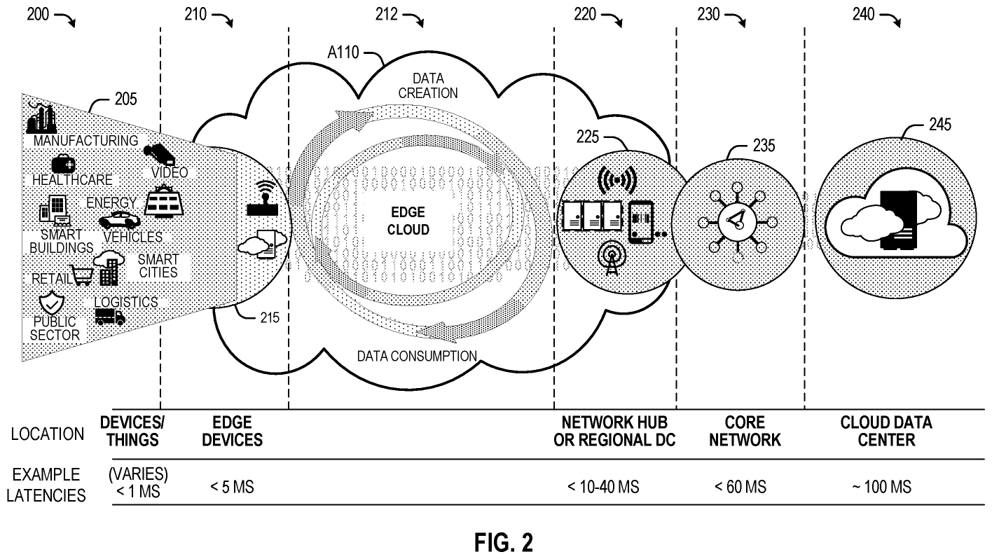

FIG. 2 illustrates operational layers among endpoints, an Edge cloud, and cloud computing environments. Specifically, FIG. 2 depicts examples of computational use cases 205, utilizing the Edge cloud 110 among multiple illustrative layers of network computing. The layers begin at an endpoint (devices and things) layer 200, which accesses the Edge cloud 110 to conduct data creation, analysis, and data consumption activities. The Edge cloud 110 may span multiple network layers, such as an Edge devices layer 210 having gateways, on-premise servers, or network equipment (nodes 215) located in physically proximate Edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the Edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the Edge devices layer 210, to even between 10 to 40 ms when communicating with nodes at the network access layer 220. Beyond the Edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close Edge”, “local Edge”, “near Edge”, “middle Edge”, or “far Edge” layers, relative to a network source and destination. For instance, from the perspective of the core network data center 235 or a cloud data center 245, a central office or content data network may be considered as being located within a “near Edge” layer (“near” to the cloud, having high latency values when communicating with the devices and endpoints of the use cases 205), whereas an access point, base station, on-premise server, or network gateway may be considered as located within a “far Edge” layer (“far” from the cloud, having low latency values when communicating with the devices and endpoints of the use cases 205). It will be understood that other categorizations of a particular network layer as constituting a “close”, “local”, “near”, “middle”, or “far” Edge may be based on latency, distance, number of network hops, or other measurable characteristics, as measured from a source in any of the network layers 200-240.

The various use cases 205 may access resources under usage pressure from incoming streams, due to multiple services utilizing the Edge cloud. To achieve results with low latency, the services executed within the Edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, Edge computing within the Edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because Edge locations may be unmanned and may even need permissioned access (e.g., when housed in a third-party location). Such issues are magnified in the Edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 110 (network layers 200-240), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco”, or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 110.

As such, the Edge cloud 110 is formed from network components and functional features operated by and within Edge gateway nodes, Edge aggregation nodes, or other Edge compute nodes among network layers 210-230. The Edge cloud 110 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 110 may be envisioned as an “Edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

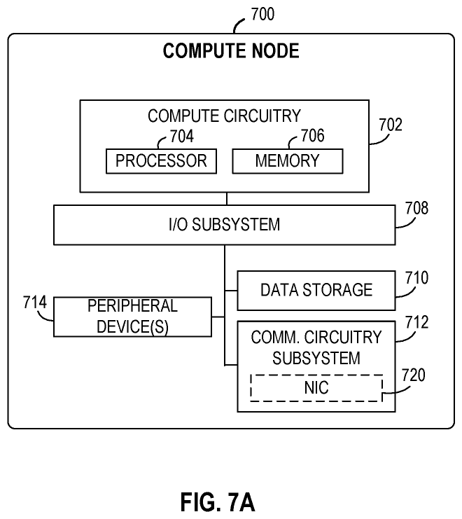

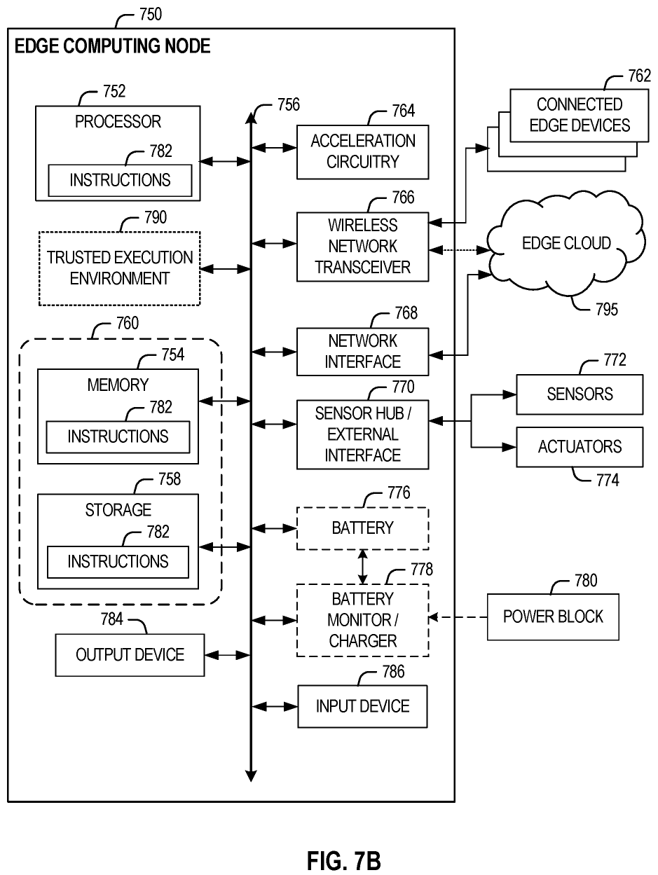

The network components of the Edge cloud 110 may be servers, multi-tenant servers, appliance computing devices, and/or any other type of computing devices. For example, the Edge cloud 110 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 7B. The Edge cloud 110 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

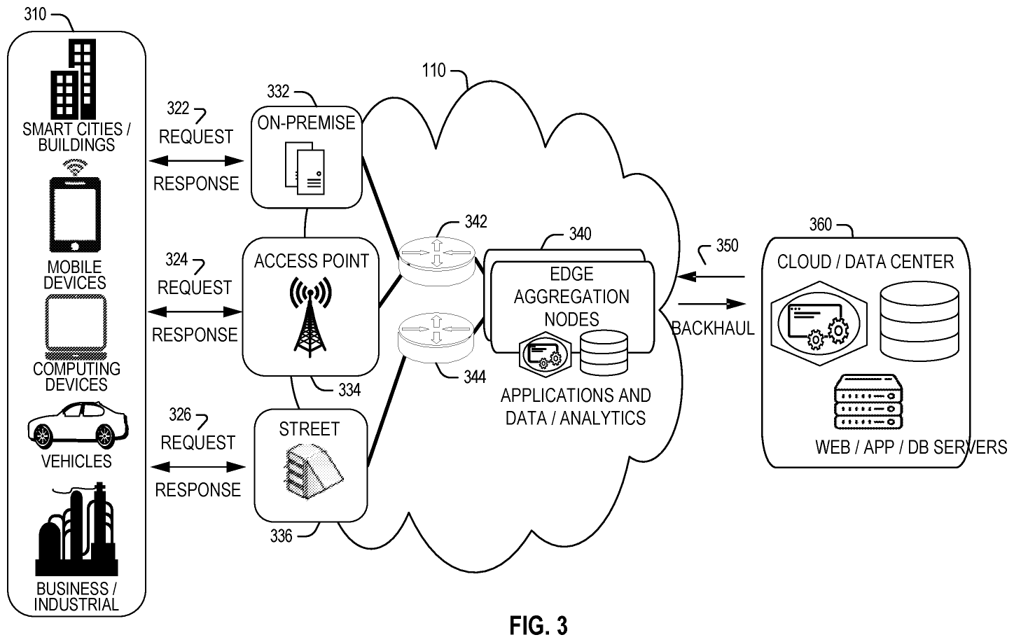

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the Edge cloud 110 to aggregate traffic and requests. Thus, within the Edge cloud 110, the TSP may deploy various compute and storage resources, such as at Edge aggregation nodes 340, to provide requested content. The Edge aggregation nodes 340 and other systems of the Edge cloud 110 are connected to a cloud or data center 360, which uses a backhaul network 350 to fulfill higher-latency requests from a cloud/data center for websites, applications, database servers, etc. Additional or consolidated instances of the Edge aggregation nodes 340 and the aggregation points 342, 344, including those deployed on a single server framework, may also be present within the Edge cloud 110 or other areas of the TSP infrastructure.

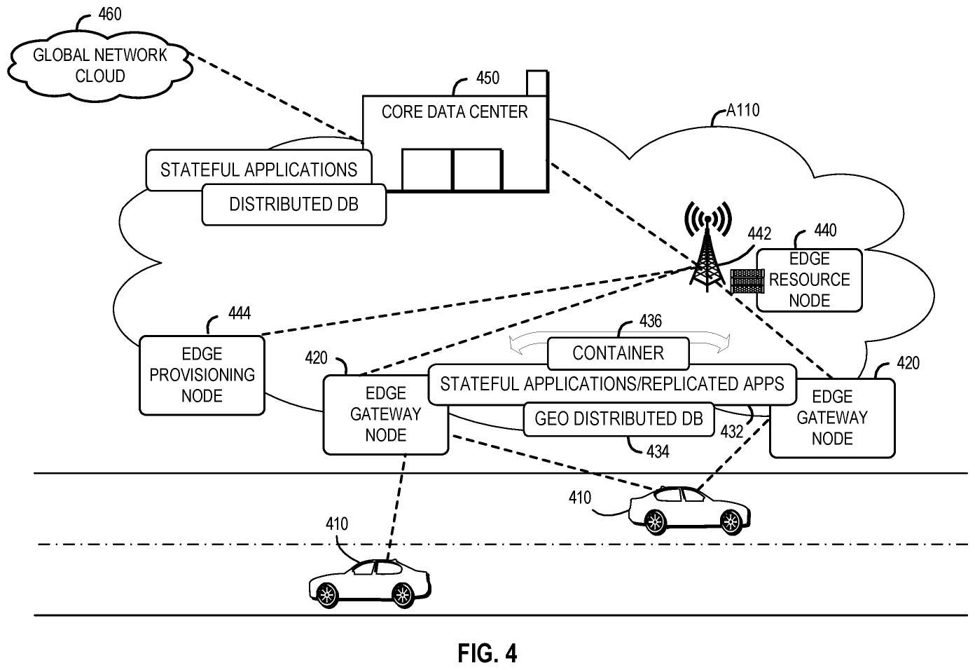

It should be appreciated that the Edge computing systems and arrangements discussed herein may be applicable in various solutions, services, and/or use cases involving mobility. As an example, FIG. 4 shows a simplified vehicle compute and communication use case involving mobile access to applications in an Edge computing system 400 that implements an Edge cloud 110. In this use case, respective client compute nodes 410 may be embodied as in-vehicle compute systems (e.g., in-vehicle navigation and/or infotainment systems) located in corresponding vehicles which communicate with the Edge gateway nodes 420 during traversal of a roadway. For instance, the Edge gateway nodes 420 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 410 and a particular Edge gateway device 420 may propagate so as to maintain a consistent connection and context for the client compute node 410. Likewise, mobile Edge nodes may aggregate at the high priority services or according to the throughput or latency resolution requirements for the underlying service(s) (e.g., in the case of drones). The respective Edge gateway devices 420 include an amount of processing and storage capabilities and, as such, some processing and/or storage of data for the client compute nodes 410 may be performed on one or more of the Edge gateway devices 420.

The Edge gateway devices 420 may communicate with one or more Edge resource nodes 440, which are illustratively embodied as compute servers, appliances or components located at or in a communication base station 442 (e.g., a base station of a cellular network). As discussed above, the respective Edge resource nodes 440 include an amount of processing and storage capabilities and, as such, some processing and/or storage of data for the client compute nodes 410 may be performed on the Edge resource node 440. For example, the processing of data that is less urgent or important may be performed by the Edge resource node 440, while the processing of data that is of a higher urgency or importance may be performed by the Edge gateway devices 420 (depending on, for example, the capabilities of each component, or information in the request indicating urgency or importance). Based on data access, data location or latency, work may continue on Edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The Edge resource node(s) 440 also communicate with the core data center 450, which may include compute servers, appliances, and/or other components located in a central location (e.g., a central office of a cellular communication network). The core data center 450 may provide a gateway to the global network cloud 460 (e.g., the Internet) for the Edge cloud 110 operations formed by the Edge resource node(s) 440 and the Edge gateway devices 420. Additionally, in some examples, the core data center 450 may include an amount of processing and storage capabilities and, as such, some processing and/or storage of data for the client compute devices may be performed on the core data center 450 (e.g., processing of low urgency or importance, or high complexity).

The Edge gateway nodes 420 or the Edge resource nodes 440 may offer the use of stateful applications 432 and a geographic distributed database 434. Although the applications 432 and database 434 are illustrated as being horizontally distributed at a layer of the Edge cloud 110, it will be understood that resources, services, or other components of the application may be vertically distributed throughout the Edge cloud (including, part of the application executed at the client compute node 410, other parts at the Edge gateway nodes 420 or the Edge resource nodes 440, etc.). Additionally, as stated previously, there can be peer relationships at any level to meet service objectives and obligations. Further, the data for a specific client or application can move from Edge to Edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 436 (or pod of containers) may be flexibly migrated from an Edge node 420 to other Edge nodes (e.g., 420, 440, etc.) such that the container with an application and workload does not need to be reconstituted, re-compiled, re-interpreted in order for migration to work. However, in such settings, there may be some remedial or “swizzling” translation operations applied. For example, the physical hardware at node 440 may differ from Edge gateway node 420 and therefore, the hardware abstraction layer (HAL) that makes up the bottom Edge of the container will be re-mapped to the physical layer of the target Edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 4 may utilize various types of mobile Edge nodes, such as an Edge node hosted in a vehicle (e.g., a car, truck, tram, train, etc.) or other mobile unit, as the Edge node will move to other geographic locations along the platform hosting it. With vehicle-to-vehicle communications, individual vehicles may even act as network Edge nodes for other cars, (e.g., to perform caching, reporting, data aggregation, etc.). Thus, it will be understood that the application components provided in various Edge nodes may be distributed in static or mobile settings, including coordination between some functions or operations at individual endpoint devices or the Edge gateway nodes 420, some others at the Edge resource node 440, and others in the core data center 450 or global network cloud 460.

In further configurations, the Edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an Edge node or data center. A trigger such as, for example, a service use case or an Edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the Edge computing system, various datacenter, Edge, and endpoint (including mobile) devices are used to “spin up” functions (e.g., activate and/or allocate function actions) that are scaled on demand. The function code gets executed on the physical infrastructure (e.g., Edge computing node) device and underlying virtualized containers. Finally, the function(s) is/are “spun down” (e.g., deactivated and/or deallocated) on the infrastructure in response to the execution being completed.

Further aspects of FaaS may enable deployment of Edge functions in a service fashion, including a support of respective functions that support Edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The Edge computing system 400 can include or be in communication with an Edge provisioning node 444. The Edge provisioning node 444 can distribute software such as the example machine (e.g., computer) readable instructions 782 of FIG. 7B, to various receiving parties for implementing any of the methods described herein. The example Edge provisioning node 444 may be implemented by any computer server, home server, content delivery network, virtual server, software distribution system, central facility, storage device, storage disk, storage node, data facility, cloud service, etc., capable of storing and/or transmitting software instructions (e.g., code, scripts, executable binaries, containers, packages, compressed files, and/or derivatives thereof) to other computing devices. Component(s) of the example Edge provisioning node 444 may be located in a cloud, in a local area network, in an Edge network, in a wide area network, on the Internet, and/or any other location communicatively coupled with the receiving party(ies). The receiving parties may be customers, clients, associates, users, etc. of the entity owning and/or operating the Edge provisioning node 444. For example, the entity that owns and/or operates the Edge provisioning node 444 may be a developer, a seller, and/or a licensor (or a customer and/or consumer thereof) of software instructions such as the example computer readable instructions 782 of FIG. 7B. The receiving parties may be consumers, service providers, users, retailers, OEMs, etc., who purchase and/or license the software instructions for use and/or re-sale and/or sub-licensing.

In an example, Edge provisioning node 444 includes one or more servers and one or more storage devices/disks. The storage devices and/or storage disks host computer readable instructions such as the example computer readable instructions 782 of FIG. 7B, as described below. Similarly to Edge gateway devices 420 described above, the one or more servers of the Edge provisioning node 444 are in communication with a base station 442 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third-party payment entity. The servers enable purchasers and/or licensors to download the computer readable instructions 782 from the Edge provisioning node 444. For example, the software instructions, which may correspond to the example computer readable instructions 782 of FIG. 7B, may be downloaded to the example processor platform/s, which is to execute the computer readable instructions to implement the methods described herein.

In some examples, the processor platform(s) that execute the computer readable instructions can be physically located in different geographic locations, legal jurisdictions, etc. In some examples, one or more servers of the Edge provisioning node 444 periodically offer, transmit, and/or force updates to the software instructions (e.g., the example computer readable instructions 782 of FIG. 7B) to ensure improvements, patches, updates, etc. are distributed and applied to the software instructions implemented at the end user devices. In some examples, different components of the computer readable instructions can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

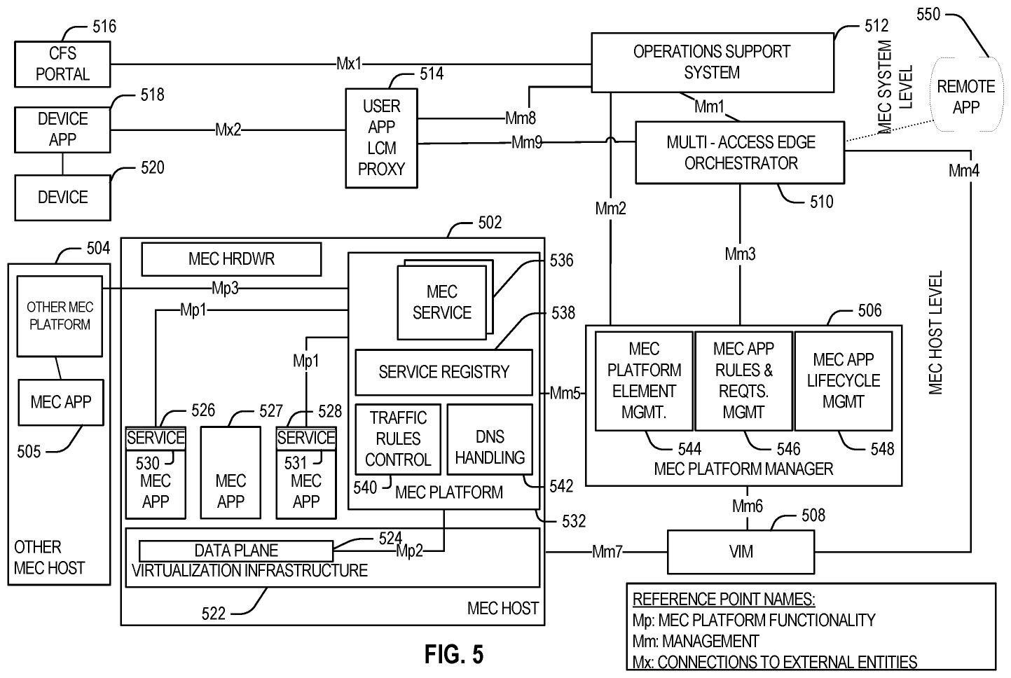

FIG. 5 illustrates a mobile Edge system reference architecture (or MEC architecture) 500, such as is indicated by ETSI MEC specifications. FIG. 5 specifically illustrates a MEC architecture 500 with MEC hosts 502 and 504 providing functionalities in accordance with the ETSI GS MEC-003 specification. In some aspects, enhancements to the MEC platform 532 and the MEC platform manager 506 may be used for providing specific computing functions within the MEC architecture 500.

Referring to FIG. 5, the MEC network architecture 500 can include MEC hosts 502 and 504, a virtualization infrastructure manager (VIM) 508, an MEC platform manager 506, an MEC orchestrator 510, an operations support system 512, a user app proxy 514, a UE app 518 running on UE 520, and CFS portal 516. The MEC host 502 can include a MEC platform 532 with filtering rules control component 540, a DNS handling component 542, a service registry 538, and MEC services 536. The MEC services 536 can include at least one scheduler, which can be used to select resources for instantiating MEC apps (or NFVs) 526, 527, and 528 upon virtualization infrastructure 522. The MEC apps 526 and 528 can be configured to provide services 530 and 531, which can include processing network communications traffic of different types associated with one or more wireless connections (e.g., connections to one or more RAN or telecom-core network entities). The MEC app 505 instantiated within MEC host 504 can be similar to the MEC apps 526-7728 instantiated within MEC host 502. The virtualization infrastructure 522 includes a data plane 524 coupled to the MEC platform via an MP2 interface. Additional interfaces between various network entities of the MEC architecture 500 are illustrated in FIG. 5.

The MEC platform manager 506 can include MEC platform element management component 544, MEC app rules and requirements management component 546, and MEC app lifecycle management component 548. The various entities within the MEC architecture 500 can perform functionalities as disclosed by the ETSI GS MEC-003 specification. In some aspects, the remote application (or app) 550 is configured to communicate with the MEC host 502 (e.g., with the MEC apps 526-528) via the MEC orchestrator 510 and the MEC platform manager 506.

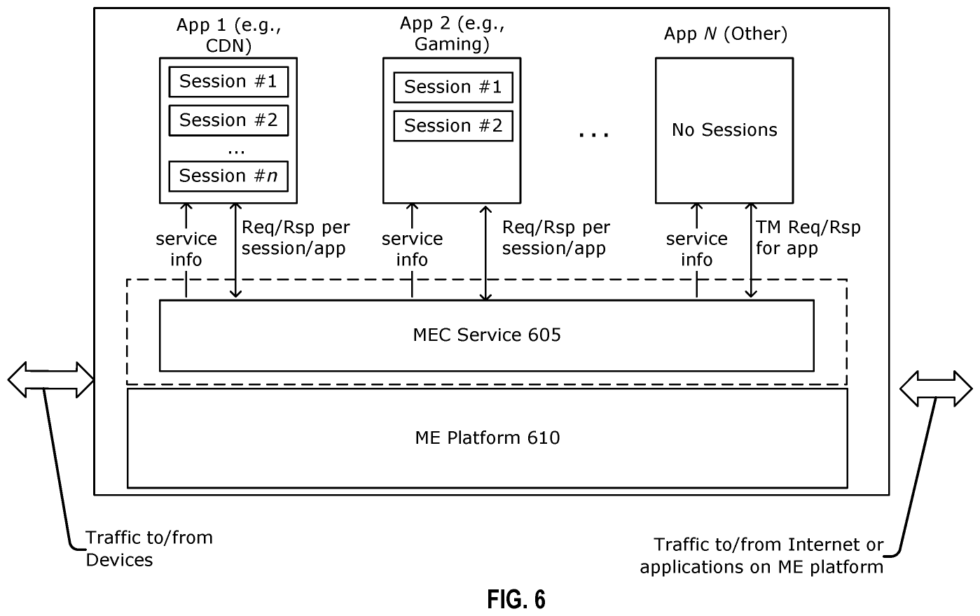

FIG. 6 illustrates an example MEC service architecture 600. MEC service architecture 600 includes the MEC service 605, a multi-access edge (ME) platform 610 (corresponding to MEC platform 532), and applications (Apps) 1 to N (where N is a number). As an example, the App 1 may be a content delivery network (CDN) app/service hosting 1 to n sessions (where n is a number that is the same or different than N), App 2 may be a gaming app/service which is shown as hosting two sessions, and App N may be some other app/service which is shown as a single instance (e.g., not hosting any sessions). Each App may be a distributed application that partitions tasks and/or workloads between resource providers (e.g., servers such as ME platform 610) and consumers (e.g., UEs, user apps instantiated by individual UEs, other servers/services, network functions, application functions, etc.). Each session represents an interactive information exchange between two or more elements, such as a client-side app and its corresponding server-side app, a user app instantiated by a UE and a MEC app instantiated by the ME platform 610, and/or the like. A session may begin when App execution is started or initiated and ends when the App exits or terminates execution. Additionally or alternatively, a session may begin when a connection is established and may end when the connection is terminated. Each App session may correspond to a currently running App instance. Additionally or alternatively, each session may correspond to a Protocol Data Unit (PDU) session or multi-access (MA) PDU session. A PDU session is an association between a UE and a DN that provides a PDU connectivity service, which is a service that provides for the exchange of PDUs between a UE and a Data Network. An MA PDU session is a PDU Session that provides a PDU connectivity service, which can use one access network at a time, or simultaneously a 3GPP access network and a non-3GPP access network. Furthermore, each session may be associated with a session identifier (ID) which is data the uniquely identifies a session, and each App (or App instance) may be associated with an App ID (or App instance ID) which is data the uniquely identifies an App (or App instance).

The MEC service 605 provides one or more MEC services 536 to MEC service consumers (e.g., Apps 1 to N). The MEC service 605 may optionally run as part of the platform (e.g., ME platform 610) or as an application (e.g., ME app). Different Apps 1 to N, whether managing a single instance or several sessions (e.g., CDN), may request specific service info per their requirements for the whole application instance or different requirements per session. The MEC service 605 may aggregate all the requests and act in a manner that will help optimize the BW usage and improve Quality of Experience (QoE) for applications.

The MEC service 605 provides a MEC service API that supports both queries and subscriptions (e.g., pub/sub mechanism) that are used over a Representational State Transfer (“REST” or “RESTful”) API or over alternative transports such as a message bus. For RESTful architectural style, the MEC APIs contain the HTTP protocol bindings for traffic management functionality.

Each Hypertext Transfer Protocol (HTTP) message is either a request or a response. A server listens on a connection for a request, parses each message received, interprets the message semantics in relation to the identified request target, and responds to that request with one or more response messages. A client constructs request messages to communicate specific intentions, examines received responses to see if the intentions were carried out, and determines how to interpret the results. The target of an HTTP request is called a “resource”. Additionally or alternatively, a “resource” is an object with a type, associated data, a set of methods that operate on it, and relationships to other resources if applicable. Each resource is identified by at least one Uniform Resource Identifier (URI), and a resource URI identifies at most one resource. Resources are acted upon by the RESTful API using HTTP methods (e.g., POST, GET, PUT, DELETE, etc.). With every HTTP method, one resource URI is passed in the request to address one particular resource. Operations on resources affect the state of the corresponding managed entities.

Considering that a resource could be anything, and that the uniform interface provided by HTTP is similar to a window through which one can observe and act upon such a thing only through the communication of messages to some independent actor on the other side, an abstraction is needed to represent (“take the place of”) the current or desired state of that thing in our communications. That abstraction is called a representation. For the purposes of HTTP, a “representation” is information that is intended to reflect a past, current, or desired state of a given resource, in a format that can be readily communicated via the protocol. A representation comprises a set of representation metadata and a potentially unbounded stream of representation data. Additionally or alternatively, a resource representation is a serialization of a resource state in a particular content format.

An origin server might be provided with, or be capable of generating, multiple representations that are each intended to reflect the current state of a target resource. In such cases, some algorithm is used by the origin server to select one of those representations as most applicable to a given request, usually based on content negotiation. This “selected representation” is used to provide the data and metadata for evaluating conditional requests constructing the payload for response messages (e.g., 200 OK, 304 Not Modified responses to GET, and the like). A resource representation is included in the payload body of an HTTP request or response message. Whether a representation is required or not allowed in a request depends on the HTTP method used (see e.g., Fielding et al., “Hypertext Transfer Protocol (HTTP/1.1): Semantics and Content”, IETF RFC 7231 (June 2014)).

The MEC API resource Universal Resource Indicators (URIs) are discussed in various ETSI MEC standards, such as those mentioned herein. The MTS API supports additional application-related error information to be provided in the HTTP response when an error occurs (see e.g., clause 6.15 of ETSI GS MEC 009 V2.1.1 (2019-01) (“[MEC009]”)). The syntax of each resource URI follows [MEC009], as well as Berners-Lee et al., “Uniform Resource Identifier (URI): Generic Syntax”, IETF Network Working Group, RFC 3986 (January 2005) and/or Nottingham, “URI Design and Ownership”, IETF RFC 8820 (June 2020). In the RESTful MEC service APIs, including the VIS API, the resource URI structure for each API has the following structure:

{apiRoot}/{apiName}/{apiVersion}/{apiSpecificSuffixes}

Here, “apiRoot” includes the scheme (“https”), host and optional port, and an optional prefix string. The “apiName” defines the name of the API (e.g., MTS API, RNI API, etc.). The “apiVersion” represents the version of the API, and the “apiSpecificSuffixes” define the tree of resource URIs in a particular API. The combination of “apiRoot”, “apiName” and “apiVersion” is called the root URI. The “apiRoot” is under control of the deployment, whereas the remaining parts of the URI are under control of the API specification. In the above root, “apiRoot” and “apiName” are discovered using the service registry (see e.g., service registry 538 in FIG. 5). It includes the scheme (“http” or “https”), host and optional port, and an optional prefix string. For the a given MEC API, the “apiName” may be set to “mec” and “apiVersion” may be set to a suitable version number (e.g., “v1” for version 1). The MEC APIs support HTTP over TLS (also known as HTTPS). All resource URIs in the MEC API procedures are defined relative to the above root URI.

The JSON content format may also be supported. The JSON format is signaled by the content type “application/j son”. The MTS API may use the OAuth 2.0 client credentials grant type with bearer tokens (see e.g., [MEC009]). The token endpoint can be discovered as part of the service availability query procedure defined in [MEC009]. The client credentials may be provisioned into the MEC app using known provisioning mechanisms.

In further examples, any of the compute nodes or devices discussed with reference to the present Edge computing systems and environment may be fulfilled based on the components depicted in FIGS. 7A and 7B. Respective Edge compute nodes may be embodied as a type of device, appliance, computer, or other “thing” capable of communicating with other Edge, networking, or endpoint components. For example, an Edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 7A, an Edge compute node 700 includes a compute engine (also referred to herein as “compute circuitry”) 702, an input/output (I/O) subsystem (also referred to herein as “I/O circuitry”) 708, data storage (also referred to herein as “data storage circuitry”) 710, a communication circuitry subsystem 712, and, optionally, one or more peripheral devices (also referred to herein as “peripheral device circuitry”) 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor (also referred to herein as “processor circuitry”) 704 and a memory (also referred to herein as “memory circuitry”) 706. The processor 704 may be embodied as any type of processor(s) capable of performing the functions described herein (e.g., executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, storage disks, or AI hardware (e.g., GPUs, programmed FPGAs, or ASICs tailored to implement an AI model such as a neural network). Such an xPU may be designed to receive, retrieve, and/or otherwise obtain programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that an xPU, an SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device (e.g., memory circuitry) is any number of block addressable memory devices, such as those based on NAND or NOR technologies (for example, Single-Level Cell (“SLC”), Multi-Level Cell (“MLC”), Quad-Level Cell (“QLC”), Tri-Level Cell (“TLC”), or some other NAND). In some examples, the memory device(s) includes a byte-addressable write-in-place three dimensional crosspoint memory device, or other byte addressable write-in-place non-volatile memory (NVM) devices, such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric transistor random access memory (FeTRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, a combination of any of the above, or other suitable memory. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may include a transistor-less stackable cross point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation such as one or more applications, data operated on by the application(s), libraries, and drivers.

In some examples, resistor-based and/or transistor-less memory architectures include nanometer scale phase-change memory (PCM) devices in which a volume of phase-change material resides between at least two electrodes. Portions of the example phase-change material exhibit varying degrees of crystalline phases and amorphous phases, in which varying degrees of resistance between the at least two electrodes can be measured. In some examples, the phase-change material is a chalcogenide-based glass material. Such resistive memory devices are sometimes referred to as memristive devices that remember the history of the current that previously flowed through them. Stored data is retrieved from example PCM devices by measuring the electrical resistance, in which the crystalline phases exhibit a relatively lower resistance value(s) (e.g., logical “0”) when compared to the amorphous phases having a relatively higher resistance value(s) (e.g., logical “1”).

Example PCM devices store data for long periods of time (e.g., approximately 10 years at room temperature). Write operations to example PCM devices (e.g., set to logical “0”, set to logical “1”, set to an intermediary resistance value) are accomplished by applying one or more current pulses to the at least two electrodes, in which the pulses have a particular current magnitude and duration. For instance, a long low current pulse (SET) applied to the at least two electrodes causes the example PCM device to reside in a low-resistance crystalline state, while a comparatively short high current pulse (RESET) applied to the at least two electrodes causes the example PCM device to reside in a high-resistance amorphous state.

In some examples, implementation of PCM devices facilitates non-von Neumann computing architectures that enable in-memory computing capabilities. Generally speaking, traditional computing architectures include a central processing unit (CPU) communicatively connected to one or more memory devices via a bus. As such, a finite amount of energy and time is consumed to transfer data between the CPU and memory, which is a known bottleneck of von Neumann computing architectures. However, PCM devices minimize and, in some cases, eliminate data transfers between the CPU and memory by performing some computing operations in-memory. Stated differently, PCM devices both store information and execute computational tasks. Such non-von Neumann computing architectures may implement vectors having a relatively high dimensionality to facilitate hyperdimensional computing, such as vectors having 10,000 bits. Relatively large bit width vectors enable computing paradigms modeled after the human brain, which also processes information analogous to wide bit vectors.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices/disks 710 may be embodied as one or more of any type(s) of physical device(s) configured for short-term or long-term storage of data such as, for example, memory devices, memory, circuitry, memory cards, flash memory, hard disk drives (HDDs), solid-state drives (SSDs), and/or other data storage devices/disks. Individual data storage devices/disks 710 may include a system partition that stores data and firmware code for the data storage device/disk 710. Individual data storage devices/disks 710 may also include one or more operating system partitions that store data files and executables for operating systems depending on, for example, the type of compute node 700.

The communication circuitry 712 may be embodied as any communication circuit, device, or collection thereof, capable of enabling communications over a network between the compute circuitry 702 and another compute device (e.g., an Edge gateway of an implementing Edge computing system). The communication circuitry 712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., an Edge gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied by a respective Edge compute node (whether a client, gateway, or aggregation node) in an Edge computing system or like forms of appliances, computers, subsystems, circuitry, or other components.

In a more detailed example, FIG. 7B illustrates a block diagram of an example of components that may be present in an Edge computing node 750 for implementing the techniques (e.g., operations, processes, methods, and methodologies) described herein. This Edge computing node 750 provides a closer view of the respective components of node 700 when implemented as or as part of a computing device (e.g., as a mobile device, a base station, server, gateway, etc.). The Edge computing node 750 may include any combination of the hardware or logical components referenced herein, and it may include or couple with any device usable with an Edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the Edge computing node 750, or as components otherwise incorporated within a chassis of a larger system.

The Edge computing device 750 may include processing circuitry in the form of a processor 752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, Calif. As an example, the processor 752 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-13 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 758 may also couple to the processor 752 via the interconnect 756. In an example, the storage 758 may be implemented via a solid-state disk drive (SSDD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 756 may couple the processor 752 to a transceiver 766, for communications with the connected Edge devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected Edge devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at a different range. For example, the Edge computing node 750 may communicate with close devices, e.g., within about 10 meters, using a local transceiver based on Bluetooth Low Energy (BLE), or another low power radio, to save power. More distant connected Edge devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in a cloud (e.g., an Edge cloud 795) via local or wide area network protocols. The wireless network transceiver 766 may be a low-power wide-area (LPWA) transceiver that follows the IEEE 802.15.4, or IEEE 802.15.4g standards, among others. The Edge computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the Edge cloud 795 or to other devices, such as the connected Edge devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components 764, 766, 768, or 770. Accordingly, in various examples, applicable means for communicating (e.g., receiving, transmitting, etc.) may be embodied by such communications circuitry.

The Edge computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific Edge computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the Edge computing node 750 to actuators 774, such as power switches, valve actuators, an audible sound generator, a visual warning device, and the like.

In some optional examples, various input/output (I/O) devices may be present within or connected to, the Edge computing node 750. For example, a display or other output device 784 may be included to show information, such as sensor readings or actuator position. An input device 786, such as a touch screen or keypad may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the Edge computing node 750. A display or console hardware, in the context of the present system, may be used to provide output and receive input of an Edge computing system; to manage components or services of an Edge computing system; identify a state of an Edge computing component or service; or to conduct any other number of management or administration functions or service use cases.

A battery 776 may power the Edge computing node 750, although, in examples in which the Edge computing node 750 is mounted in a fixed location, it may have a power supply coupled to an electrical grid, or the battery may be used as a backup or for temporary capabilities. The battery 776 may be a lithium ion battery, or a metal-air battery, such as a zinc-air battery, an aluminum-air battery, a lithium-air battery, and the like.

A battery monitor/charger 778 may be included in the Edge computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LT5990 from Linear Technologies, an ADT7488A from ON Semiconductor of Phoenix Ariz., or an IC from the UCD90xxx family from Texas Instruments of Dallas, Tex. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the Edge computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the Edge computing node 750. A wireless battery charging circuit, such as an LTC4020 chip from Linear Technologies of Milpitas, Calif., among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application specific integrated circuit (ASIC).

In an example, the instructions 782 provided via the memory 754, the storage 758, or the processor 752 may be embodied as a non-transitory, machine-readable medium 760 including code to direct the processor 752 to perform electronic operations in the Edge computing node 750. The processor 752 may access the non-transitory, machine-readable medium 760 over the interconnect 756. For instance, the non-transitory, machine-readable medium 760 may be embodied by devices described for the storage 758 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable. As used herein, the term “non-transitory computer-readable medium” is expressly defined to include any type of computer readable storage device and/or storage disk and to exclude propagating signals and to exclude transmission media.

Also in a specific example, the instructions 782 on the processor 752 (separately, or in combination with the instructions 782 of the machine readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 750 through the TEE 790 and the processor 752.

While the illustrated examples of FIG. 7A and FIG. 7B include example components for a compute node and a computing device, respectively, examples disclosed herein are not limited thereto. As used herein, a “computer” may include some or all of the example components of FIGS. 7A and/or 7B in different types of computing environments. Example computing environments include Edge computing devices (e.g., Edge computers) in a distributed networking arrangement such that particular ones of participating Edge computing devices are heterogenous or homogeneous devices. As used herein, a “computer” may include a personal computer, a server, user equipment, an accelerator, etc., including any combinations thereof. In some examples, distributed networking and/or distributed computing includes any number of such Edge computing devices as illustrated in FIGS. 7A and/or 7B, each of which may include different sub-components, different memory capacities, I/O capabilities, etc. For example, because some implementations of distributed networking and/or distributed computing are associated with particular desired functionality, examples disclosed herein include different combinations of components illustrated in FIGS. 7A and/or 7B to satisfy functional objectives of distributed computing tasks. In some examples, the term “compute node” or “computer” only includes the example processor 704, memory 706 and I/O subsystem 708 of FIG. 7A. In some examples, one or more objective functions of a distributed computing task(s) rely on one or more alternate devices/structure located in different parts of an Edge networking environment, such as devices to accommodate data storage (e.g., the example data storage 710), input/output capabilities (e.g., the example peripheral device(s) 714), and/or network communication capabilities (e.g., the example NIC 720).

In some examples, computers operating in a distributed computing and/or distributed networking environment (e.g., an Edge network) are structured to accommodate particular objective functionality in a manner that reduces computational waste. For instance, because a computer includes a subset of the components disclosed in FIGS. 7A and 7B, such computers satisfy execution of distributed computing objective functions without including computing structure that would otherwise be unused and/or underutilized. As such, the term “computer” as used herein includes any combination of structure of FIGS. 7A and/or 7B that is capable of satisfying and/or otherwise executing objective functions of distributed computing tasks. In some examples, computers are structured in a manner commensurate to corresponding distributed computing objective functions in a manner that downscales or upscales in connection with dynamic demand. In some examples, different computers are invoked and/or otherwise instantiated in view of their ability to process one or more tasks of the distributed computing request(s), such that any computer capable of satisfying the tasks proceed with such computing activity.

In the illustrated examples of FIGS. 7A and 7B, computing devices include operating systems. As used herein, an “operating system” is software to control example computing devices, such as the example Edge compute node 700 of FIG. 7A and/or the example Edge compute node 750 of FIG. 7B. Example operating systems include, but are not limited to consumer-based operating systems (e.g., Microsoft® Windows® 10, Google® Android® OS, Apple® Mac® OS, etc.). Example operating systems also include, but are not limited to industry-focused operating systems, such as real-time operating systems, hypervisors, etc. An example operating system on a first Edge compute node may be the same or different than an example operating system on a second Edge compute node. In some examples, the operating system invokes alternate software to facilitate one or more functions and/or operations that are not native to the operating system, such as particular communication protocols and/or interpreters. In some examples, the operating system instantiates various functionalities that are not native to the operating system. In some examples, operating systems include varying degrees of complexity and/or capabilities. For instance, a first operating system corresponding to a first Edge compute node includes a real-time operating system having particular performance expectations of responsivity to dynamic input conditions, and a second operating system corresponding to a second Edge compute node includes graphical user interface capabilities to facilitate end-user I/O.

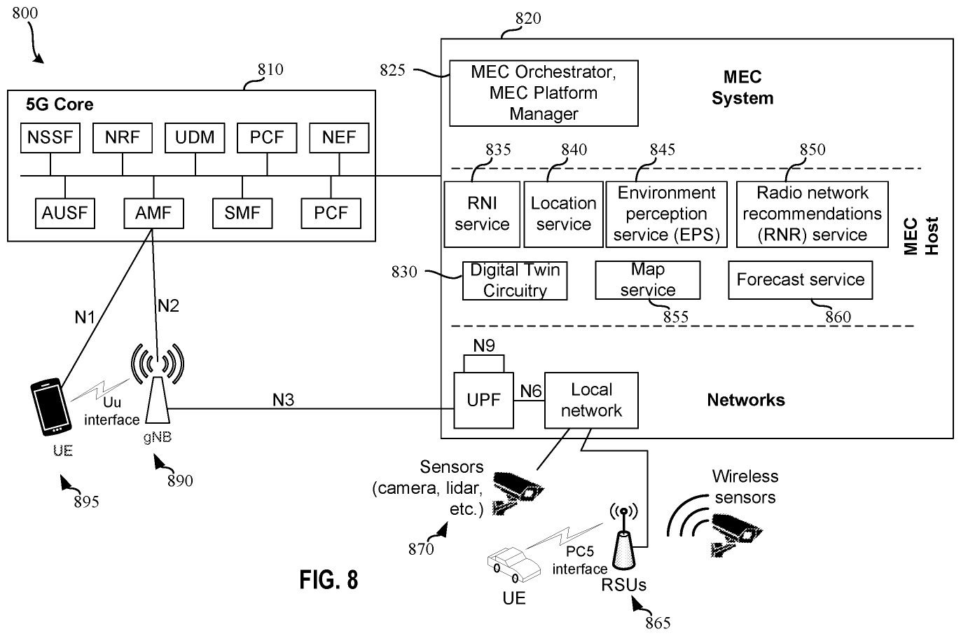

FIG. 8 is a block diagram illustrating an example architecture implemented in accordance with the teachings of this disclosure. In particular, FIG. 8 shows a high level architecture 800 of the framework disclosed herein, upon which the digital twin based predictions can be used to improve the robustness of radio networks. The illustrated example of FIG. 8 shows a 5G core 810 in communication with a MEC system 820. Here, the integration of MEC system 820 with 5G core 810 is shown as an example and considered for explanation of ideas throughout this disclosure. However, the techniques of this disclosure can be applied to other networks like LTE, beyond 5G, etc. In such examples, the interface(s) with the MEC system 820 might be different. In the illustrated example of FIG. 8, the MEC system 820 includes a MEC orchestrator 825, digital twin circuitry 830, a radio network information (RNI) service 835, a location service 840, an environment perception service 845, a radio network recommendations service 850, a map service 855, a forecast service, one or more road side units (RSUs) 865, and one or more sensors 870. In the illustrated example of FIG. 8, the one or more sensors 870 includes one or more cameras, lidars, etc. The 5G core 810 is in communication with a g node b (gNB) 890, and a UE 895.

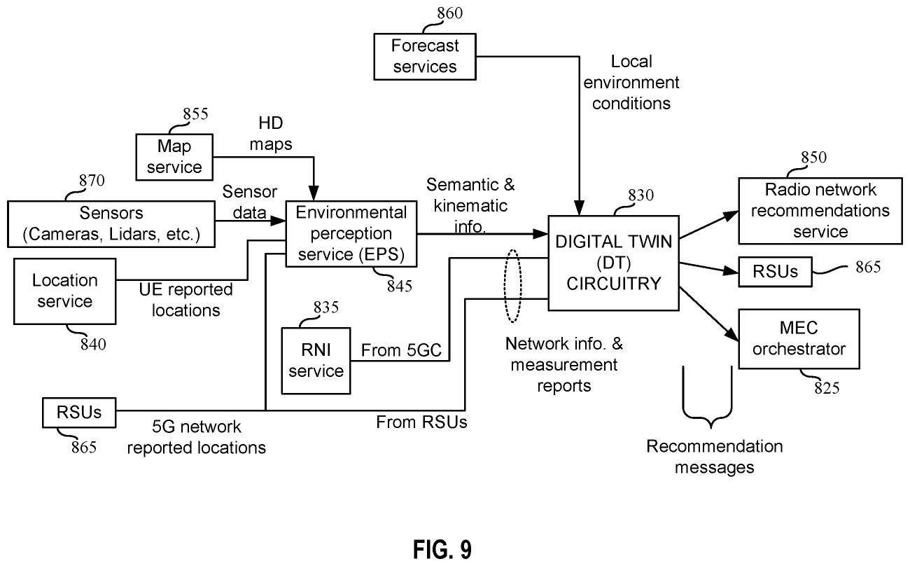

FIG. 9 is a block diagram illustrating relationships between functional entities within the MEC system 820 of FIG. 8, and a dataflow between those entities. As shown in the illustrated example of FIG. 9, the digital twin circuitry receives information from one or more of the forecast services 860, the environmental perception service 845, the RNI service 835, and the RSUs 865. The example digital twin circuitry 830 provides recommendation messages to one or more of the radio network recommendations service 850, the RSUs 865, and/or the MEC orchestrator 825.

The environmental perception service (EPS) 845 receives and/or collects information from one or more of the map service 855, the sensors 870, the location service 840, and/or the RSUs 865. The EPS 845 collects live information about the environment from different sources such as connected sensors 870 (wired or wireless), RSUs 865, and Location service 840. The EPS 845 also obtains static information of the environment such as buildings, road infrastructure, etc., via high definition (HD) maps provided by map service 855. The EPS 845 processes the received and/or collected data using, for example, sensor fusion methods, to develop a contextual understanding of the environment. Recent advancements in the field of autonomous systems have allowed for real-time environmental perception capabilities with accurate semantic and kinematic details. The EPS 845 provides the semantic and kinematic information to the DT circuitry 830. While in the illustrated example of FIG. 9, the EPS 845 processes such received and/or collected information for generation of the semantic and kinematic information, in some examples, the DT circuitry 830 may itself process the received and/or collected information.

For the EPS 845 to map the perceived objects (vehicles, pedestrians, etc.) to the UE IDs (network configured IDs) of wireless networks, the EPS 845 matches the locations reported by the UEs (via network) to the estimated locations of the perceived objects. The EPS module can obtain location related information about the UEs and other network nodes from Location service 840. The location service 840, in turn, retrieves the location information from the 5G system which supports both 3GPP and non-3GPP technologies to achieve higher positioning accuracies. In some examples, the RSUs 865 also provide location information to the EPS which are reported by the UEs through periodic broadcast messages such as basic safety message (BSM), collective perception message (CPM), etc.

As noted above, a digital twin is a real-time virtual representation of a physical entity such as an object, a system, or a process. Using connected sensors, this cyber-physical technology permits connectivity and synchronization between the physical components and their digital counterparts. Further, through analytics and simulations using a digital model (e.g., implemented using the DT circuitry 830), a digital twin system can produce future predictions with rich insights about the physical entity.

The DT circuitry 830 shown in FIG. 8 creates a virtual environment of a physical scenario in which the physical entities in the real scenario (e.g., vehicles, pedestrians, buildings, road infrastructure, etc.) are represented as digital actors (e.g., models) in the virtual environment. The DT circuitry 830 obtains live information of the semantic and kinematic parameters of the physical entities in the environment from Environmental Perception Service 845. The semantic parameters provide information about the type of an entity such as person, car, bicyclist, building, road, etc., while the kinematic parameters provide information about the mobility of an entity that include position, velocity, heading direction, etc. The DT circuitry 830 can obtain wireless access network related information via RNI service 835 that provides details such as radio network conditions and measurements, information about connected UEs, radio access bearers, etc. Additionally, the DT circuitry 830 can also obtain wireless network related information pertaining to the RSUs 865 that are connected to the MEC system 820 directly. The DT circuitry 830 can also get information about the local environmental conditions (such as rain, fog, visibility conditions, etc.) through the external forecast services 860.

The DT module continuously synchronizes the digital models (actors) in a virtual environment with their respective physical entities through the live information obtained from sources including, for example, EPS 845, RNI 835, RSUs 865, etc. Then, the DT circuitry 830 performs analytics and simulations using the digital models to generate future predictions (e.g., in real-time) of the parameters of interest such as future positions of actors, wireless channel state, blocking of LoS links, etc. The scope of the simulations covers the parameters of interest like locations and velocities of users, channel conditions (received signal strength, SINR, etc.) at the UEs, etc. The simulations in the DT circuitry 830 may be based on deterministic and/or AI based algorithms to generate the future predictions. The live measured parameters, such as UE locations, SINR, etc., received by the DT circuitry 830 can be used as ground truth data to continuously train the AI models and improve the prediction accuracies.

Based on the insights obtained from future predictions, the DT circuitry 830 generates recommendation messages proactively which can be used to improve resiliency of the network and services, and robustness of the wireless links. The recommendation messages generated by the DT circuitry 830 can include suggestions related to UE handover (HO), MEC applications mobility, communications and compute resource allocations, beam management, network routing paths, etc. The DT circuitry 830 can send the recommendation messages to, for example, The 5G network via the proposed radio network recommendations (RNR) service, the connected RSUs' management planes via the MEC host's local network, and/or the MEC orchestrator.

The example radio network recommendations (RNR) service 850 enables recommendations to be provided to the core network and gNBs. In some examples, the recommendations may be in the form of configurations and/or other parameters. In this manner, the DT circuitry 830 uses the RNR service 850 to convey recommendation messages to the 5G network 810 of FIG. 8. The RNR service accesses the services provided by relevant 5G core network functions via the MEC orchestrator 825 to convey the recommendation of the DT circuitry 830.

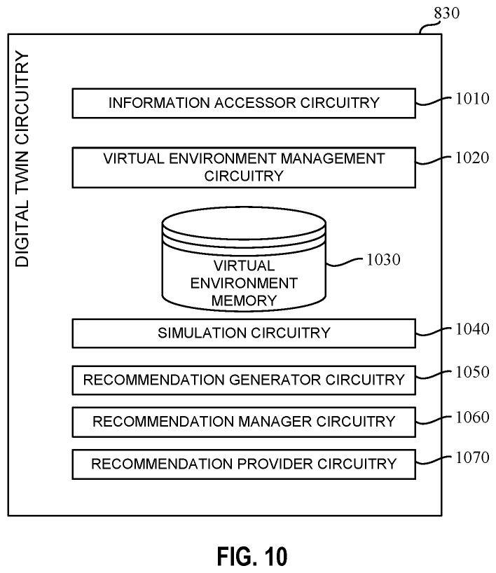

FIG. 10 is a block diagram of an example implementation of the example digital twin circuitry 830 of FIGS. 8 and/or 9. The example digital twin circuitry 830 includes information accessor circuitry 1010, virtual environment management circuitry 1020, a virtual environment memory 1030, simulation circuitry 1040, recommendation generator circuitry 1050, recommendation manager circuitry 1060, and recommendation provider circuitry 1070.

The example information accessor circuitry 1010 of the illustrated example of FIG. 10 accesses semantic and kinematic statistic information from the EPS 845. The example information accessor circuitry 1010 accesses network information and measurement reports from the RNI service 835, and/or the RSUs 865. In some examples, the information accessor circuitry 1010 also accesses information from the forecast services 860.

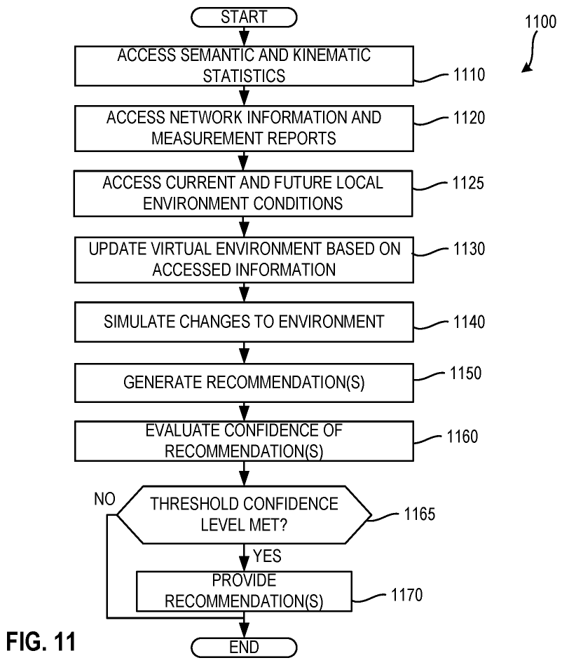

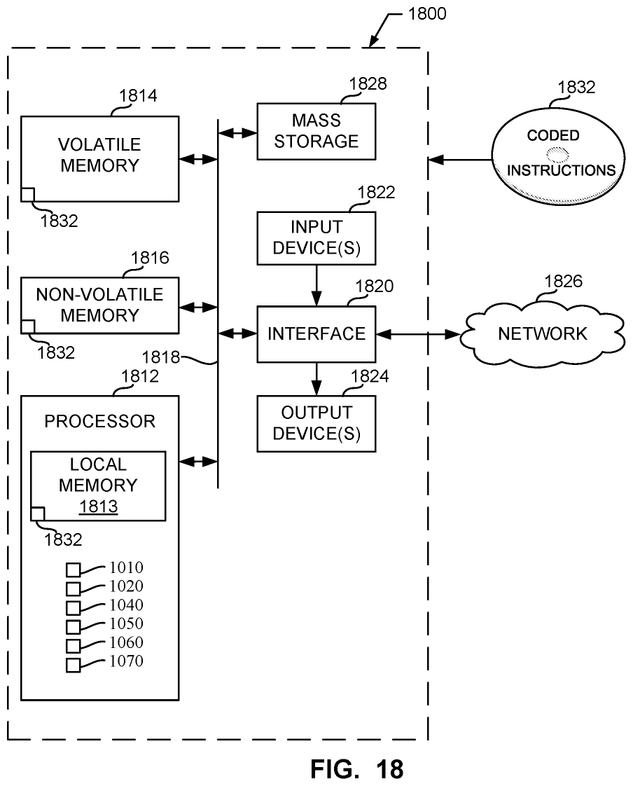

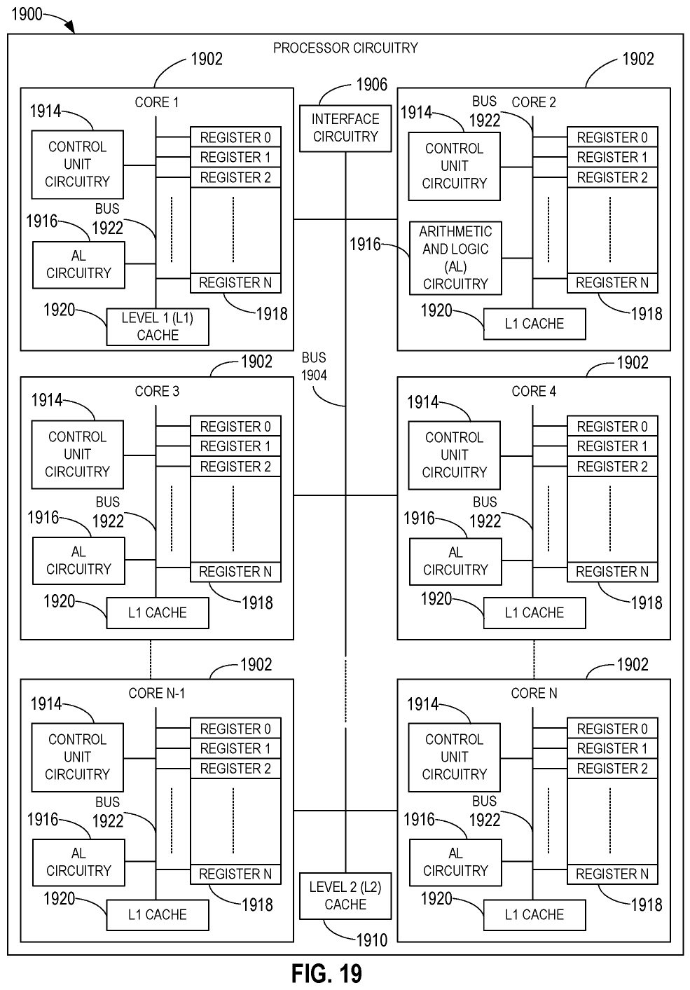

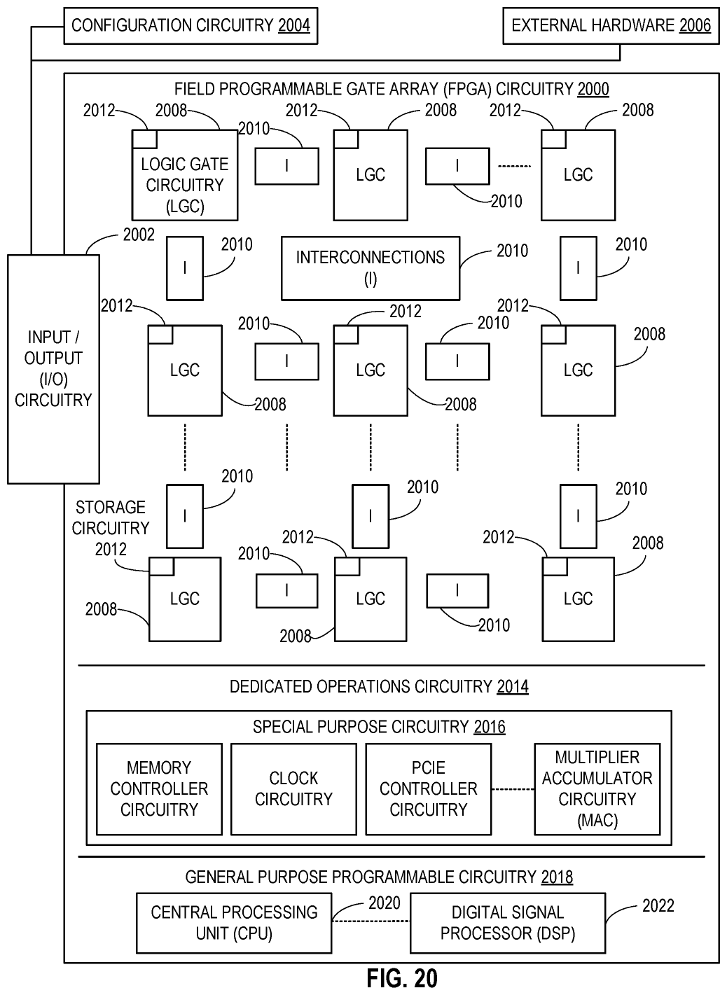

In some examples, the digital twin circuitry 830 includes means for accessing. For example, the means for accessing may be implemented by the information accessor circuitry 1010. In some examples, the information accessor circuitry 1010 may be implemented by machine executable instructions such as that implemented by at least blocks 1110, and 1120 of FIG. 11 executed by processor circuitry, which may be implemented by the example processor circuitry 1812 of FIG. 18, the example processor circuitry 1900 of FIG. 19, and/or the example Field Programmable Gate Array (FPGA) circuitry 2000 of FIG. 20. In other examples, the information accessor circuitry 1010 is implemented by other hardware logic circuitry, hardware implemented state machines, and/or any other combination of hardware, software, and/or firmware. For example, the information accessor circuitry 1010 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

The example virtual environment management circuitry 1020 of the illustrated example of FIG. 10 updates a virtual environment stored in the virtual environment memory 1030 based on the accessed information. In this manner, the virtual environment mirrors (e.g., is a digital twin of) the physical environment.

In some examples, the digital twin circuitry 830 includes means for updating. For example, the means for updating may be implemented by the virtual environment management circuitry 1020. In some examples, the virtual environment management circuitry 1020 may be implemented by machine executable instructions such as that implemented by at least block 1130 of FIG. 11 executed by processor circuitry, which may be implemented by the example processor circuitry 1812 of FIG. 18, the example processor circuitry 1900 of FIG. 19, and/or the example Field Programmable Gate Array (FPGA) circuitry 2000 of FIG. 20. In other examples, the virtual environment management circuitry 1020 is implemented by other hardware logic circuitry, hardware implemented state machines, and/or any other combination of hardware, software, and/or firmware. For example, the virtual environment management circuitry 1020 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

The example virtual environment memory 1030 of the illustrated example of FIG. 10 is implemented by any memory, storage device and/or storage disc for storing data such as, for example, flash memory, magnetic media, optical media, solid state memory, hard drive(s), thumb drive(s), etc. Furthermore, the data stored in the example virtual environment memory 1030 may be in any data format such as, for example, binary data, comma delimited data, tab delimited data, structured query language (SQL) structures, etc. While, in the illustrated example, the virtual environment memory 1030 is illustrated as a single device, the example virtual environment memory 1030 and/or any other data storage devices described herein may be implemented by any number and/or type(s) of memories. In the illustrated example of FIG. 10, the example virtual environment memory 1030 stores a virtual representation of state of entities in the physical environment including both entities (e.g., devices) in communication with the network as well as entities (e.g., objects) not in communication with the network.

The example simulation circuitry 1040 of the illustrated example of FIG. 10 simulates changes to the environment represented by the virtual environment memory 1030. Such changes may be based on, for example, the semantic and kinematic statistics and/or the network information and measurement reports accessed by the information accessor circuitry 1010. In this manner, the simulated changes represent possible changes to the virtual environment and, as a result, possible changes to the physical environment. In response to such potential changes, various tasks may be beneficial to the reliability and/or resiliency of the network including, for example, performing a handover operation and/or initializing resources in anticipation of a handover operation.

In some examples, the digital twin circuitry 830 includes means for simulating. For example, the means for simulating may be implemented by the simulation circuitry 1040. In some examples, the virtual simulation circuitry 1040 may be implemented by machine executable instructions such as that implemented by at least block 1140 of FIG. 11 executed by processor circuitry, which may be implemented by the example processor circuitry 1812 of FIG. 18, the example processor circuitry 1900 of FIG. 19, and/or the example Field Programmable Gate Array (FPGA) circuitry 2000 of FIG. 20. In other examples, the simulation circuitry 1040 is implemented by other hardware logic circuitry, hardware implemented state machines, and/or any other combination of hardware, software, and/or firmware. For example, the simulation circuitry 1040 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

The example recommendation generator circuitry 1050 of the illustrated example of FIG. 10 generates one or more recommendations. Such recommendations may include, for example, performance of a handover operation and/or initializing resources in anticipation of a handover operation.

In some examples, the digital twin circuitry 830 includes means for generating. For example, the means for generating may be implemented by the recommendation generator circuitry 1050. In some examples, the recommendation generator circuitry 1050 may be implemented by machine executable instructions such as that implemented by at least block 1150 of FIG. 11 executed by processor circuitry, which may be implemented by the example processor circuitry 1812 of FIG. 18, the example processor circuitry 1900 of FIG. 19, and/or the example Field Programmable Gate Array (FPGA) circuitry 2000 of FIG. 20. In other examples, the recommendation generator circuitry 1050 is implemented by other hardware logic circuitry, hardware implemented state machines, and/or any other combination of hardware, software, and/or firmware. For example, the recommendation generator circuitry 1050 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

The example recommendation manager circuitry 1060 of the illustrated example of FIG. 10 determines whether any recommendations meet a threshold confidence level. In some examples, multiple different recommendations may meet the threshold confidence level. In such an example, the highest confidence non-conflicting recommendations are provided to the appropriate entities. Two recommendations may be conflicting when those recommendations would cause actions that would be in conflict with another.

In some examples, the digital twin circuitry 830 includes means for managing. For example, the means for managing may be implemented by the recommendation manager circuitry 1060. In some examples, the recommendation manager circuitry 1060 may be implemented by machine executable instructions such as that implemented by at least block 1160, 1165 of FIG. 11 executed by processor circuitry, which may be implemented by the example processor circuitry 1812 of FIG. 18, the example processor circuitry 1900 of FIG. 19, and/or the example Field Programmable Gate Array (FPGA) circuitry 2000 of FIG. 20. In other examples, the recommendation manager circuitry 1060 is implemented by other hardware logic circuitry, hardware implemented state machines, and/or any other combination of hardware, software, and/or firmware. For example, the recommendation manager circuitry 1060 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

The example recommendation provider circuitry 1070 of the illustrated example of FIG. 10 provides recommendation information to various other network equipment. In some examples, the recommendation provider circuitry 1070 communicates with the radio network recommendations service 850 to provide radio network recommendations to elements within the 5G core 810 (e.g., to directly recommend to a gNB to perform a task). In some examples, the recommendation provider circuitry 1070 communicates with one or more RSUs to facilitate recommendations related to beam forming. In some examples, the recommendation provider circuitry 1070 communicates with the MEC orchestrator 825 to facilitate mobility management.

In some examples, the digital twin circuitry 830 includes means for providing. For example, the means for providing may be implemented by the recommendation provider circuitry 1070. In some examples, the recommendation provider circuitry 1070 may be implemented by machine executable instructions such as that implemented by at least block 1170 of FIG. 11 executed by processor circuitry, which may be implemented by the example processor circuitry 1812 of FIG. 18, the example processor circuitry 1900 of FIG. 19, and/or the example Field Programmable Gate Array (FPGA) circuitry 2000 of FIG. 20. In other examples, the recommendation provider circuitry 1070 is implemented by other hardware logic circuitry, hardware implemented state machines, and/or any other combination of hardware, software, and/or firmware. For example, the recommendation provider circuitry 1070 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the digital twin circuitry 830 of FIG. 8 is illustrated in FIG. 10, one or more of the elements, processes, and/or devices illustrated in FIG. 10 may be combined, divided, re-arranged, omitted, eliminated, and/or implemented in any other way. Further, the example information accessor circuitry 1010, the example virtual environment management circuitry 1020, the example simulation circuitry 1040, the example recommendation generator circuitry 1050, the example recommendation manager circuitry 1060, the example recommendation provider circuitry 1070, and/or, more generally, the example digital twin circuitry 830 of FIG. 8, may be implemented by hardware, software, firmware, and/or any combination of hardware, software, and/or firmware. Thus, for example, any of the example information accessor circuitry 1010, the example virtual environment management circuitry 1020, the example simulation circuitry 1040, the example recommendation generator circuitry 1050, the example recommendation manager circuitry 1060, the example recommendation provider circuitry 1070, and/or, more generally, the example digital twin circuitry 830 of FIG. 8, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example information accessor circuitry 1010, the example virtual environment management circuitry 1020, the example simulation circuitry 1040, the example recommendation generator circuitry 1050, the example recommendation manager circuitry 1060, the example recommendation provider circuitry 1070, and/or, more generally, the example digital twin circuitry 830 of FIG. 8 is/are hereby expressly defined to include a non-transitory computer readable storage device or storage disk such as a memory, a digital versatile disk (DVD), a compact disk (CD), a Blu-ray disk, etc., including the software and/or firmware. Further still, the example digital twin circuitry 830 of FIG. 8 may include one or more elements, processes, and/or devices in addition to, or instead of, those illustrated in FIG. 10, and/or may include more than one of any or all of the illustrated elements, processes and devices.

A flowchart representative of example hardware logic circuitry, machine readable instructions, hardware implemented state machines, and/or any combination thereof for implementing the digital twin circuitry 830 of FIG. 10 is shown in FIG. 11. The machine readable instructions may be one or more executable programs or portion(s) of an executable program for execution by processor circuitry, such as the processor circuitry 1812 shown in the example processor platform 1800 discussed below in connection with FIG. 18 and/or the example processor circuitry discussed below in connection with FIGS. 19 and/or 20. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 18, many other methods of implementing the example digital twin circuitry 830 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 11 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 11 is a flowchart representative of example machine readable instructions and/or example operations 1100 that may be executed and/or instantiated by processor circuitry to generate a recommendation. The machine readable instructions and/or operations 1100 of FIG. 11 begin at block 1110, at which the information accessor circuitry 1010 accesses semantic and kinematic statistic information from the EPS 845. (Block 1110). The example information accessor circuitry 1010 accesses network information and measurement reports from the RNI service 835, and/or the RSUs 865. (Block 1120). In some examples, the information accessor circuitry 1010 also accesses current and future local environment conditions from the forecast services 860. (Block 1125). In some examples, the current and future local environment conditions may represent current and/or predicted weather conditions including, for example, temperature, rain, snow, fog, etc. In examples disclosed herein, the semantic and kinematic statistic information and the network information and measurement reports may be generically referred to as operational statistics.

The virtual environment management circuitry 1020 updates the virtual environment memory 1030 based on the accessed information. (Block 1130). In this manner, the virtual environment memory 1030 represents a virtual environment that mirrors (e.g., is a digital twin of) the physical environment. The example simulation circuitry 1040 simulates changes to the environment represented by the virtual environment memory 1030. (Block 1140). Such changes may be based on, for example, the semantic and kinematic statistics and/or the network information and measurement reports received at blocks 1110 and 1120, respectively. In this manner, the simulated changes represent possible changes to the virtual environment and, as a result, possible changes to the physical environment. If, for example, a UE was moving at a rate of speed that would soon cause the UE to transition from having LoS of a gNB to not having LoS of the gNB, simulation of such change can be used to begin a handover from the gNB to another gNB prior to the UE not having LoS with the gNB.

Based on the simulated changes, the recommendation generator 1050 generates one or more recommendations. (Block 1150). In some examples, multiple different changes may be simulated, and those different changes may have varying degrees of confidence that those changes are likely to occur. In some examples, multiple different situational changes may result in a same recommendation (e.g., perform a handoff from a first gNB to a second gNB). For example, considering the above LoS example, there may be a 50% likelihood that the UE continues on its current path of travel at its current rate of speed, a 25% likelihood that the UE stops moving, and a 25% likelihood that the UE continues on its current path of travel at an increased rate of speed. In both of the situations where the UE continues on its current path (e.g., totaling to a 75% likelihood), a handover may be recommended, whereas in the situation where the UE stops moving, no handover is recommended. The recommendation manager circuitry 1060 evaluates the confidence(s) of varying situational changes, and aggregates outcomes to associate a confidence for each recommendation. (Block 1160). Continuing the above example, there may therefore be a 75% confidence that a handover should be initiated.

The example recommendation manager circuitry 1060 determines whether any recommendations meet a threshold confidence level. (Block 1165). If the threshold confidence level is met (e.g., block 1165 returns a result of YES), the recommendation (e.g., the recommendation having the threshold confidence) is provided to the relevant recipient by the recommendation provider circuitry 1070. (Block 1170). In some examples, multiple different recommendations may meet the threshold confidence level. In such an example, the highest confidence non-conflicting recommendations are provided to the appropriate entities. Two recommendations may be conflicting when those recommendations would cause actions that would be in conflict with another. For example, if there were a first recommendation to handover a UE from a source node to a first target node, and a second recommendation to handover the UE from the source node to a second target node, the recommendation having the higher confidence would be selected, as the UE cannot handover to both the first and second node.

After providing the recommendation(s) to the appropriate entity(ies), the example process 1100 of FIG. 11 terminates. The example process of FIG. 11 may be repeated, however, on a periodic basis (e.g., every one hundred milliseconds, every second, every minute, etc.) and/or on an a-periodic basis (e.g., in response to receipt of updated semantic and/or kinematic information, in response to receipt of updated network information and/or measurement reports).

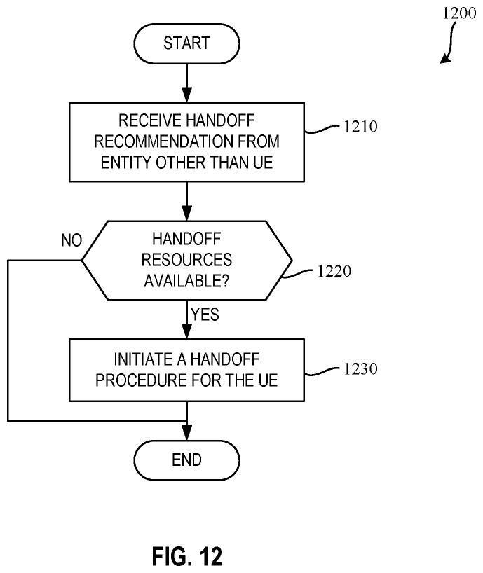

FIG. 12 is a flowchart representative of example machine readable instructions and/or example operations 1100 that may be executed and/or instantiated by processor circuitry to perform a handoff in response to a recommendation. In existing 5G systems, the HO decisions are taken solely based on measurements reported by the UEs. In the baseline HO process, a UE in connected mode is configured by gNB to report certain measurement events, based on which the gNB makes HO decisions. When the gNB decides to HO a UE to a target gNB, the UE initiates HO preparation phase with the target gNB, and after that the gNB sends a command to the UE to execute the HO process. However, depending on the environment and the UE's velocity, there are certain chances for HoF and ping-pong effects. For example, when a high-speed UE's link abruptly changes from LoS to NLoS due to blocking by a building. There are certain HO related parameters like RSRP/RSRQ/SINR thresholds, hysteresis, offset, etc., which can be adjusted appropriately to reduce HoF. However, due to uncertainties in the environment and dynamics of a UE's behavior, the UEs may experience significant radio link failures (RLFs) and HoFs as a result of too-early or too-late HOs.

The machine readable instructions and/or operations 1200 of FIG. 12 begin at block 1210, at which the gNB 890 receives a handoff recommendation from an entity other than the UE 895. (Block 1210). That is, as opposed to existing approaches, where the UI initiates the HO preparation, the recommendation to initiate the HO is provided by another entity such as, for example the digital twin circuitry 830. The example gNB determines whether the HO resources are available (Block 1220) and, if so, initiates a handoff procedure for the UE. (Block 1230). If the HO resources are not available (e.g., block 1220 returns a result of NO), no action is taken.

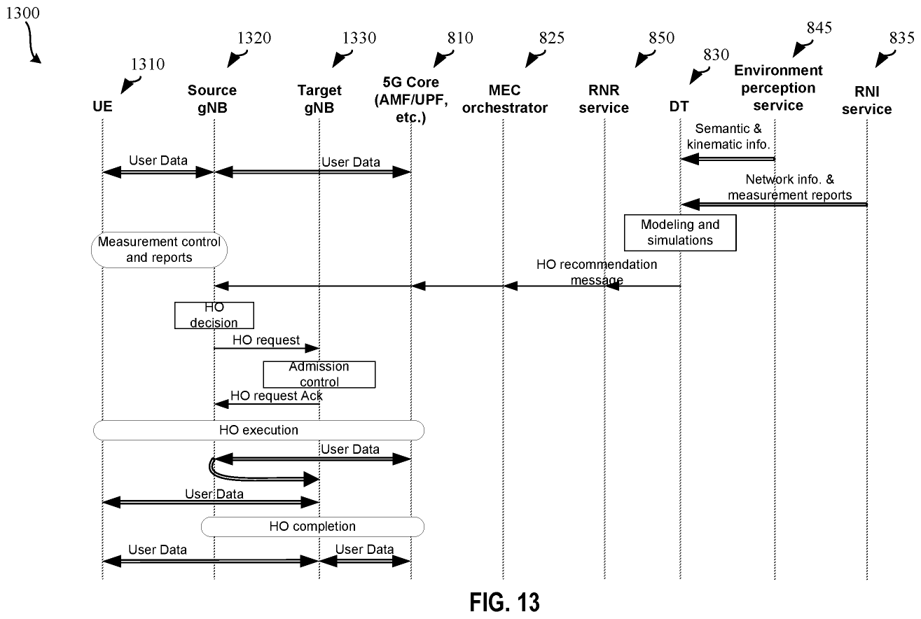

FIG. 13 is a communication diagram 1300 illustrating proactive mobility management to reduce handover failures. In the illustrate example of FIG. 13, the DT circuitry 830 collects semantic and kinematic information, and network information and measurement reports. Using this information, the DT circuitry 830 simulates a virtual environment and generates a recommendation message. In the illustrated example of FIG. 13, the recommendation message is a handover recommendation message.

In examples disclosed herein, the HO recommendation message includes a list of HO recommendation structures, each corresponding to a UE that may require HO in near future. Each recommendation structure includes, for example, a recommendation ID, a network ID for the UE, a recommendation type (e.g., new, update, revoke, etc.), a timestamp indicating a recommended future time at which the source gNB may start HO preparation, a timestamp indicating a future time before which the HO execution should be completed to avoid HOF or RLF, a recommended HO type (e.g., HO, CHO, dual connectivity, etc.), one (in case of HO/CHO/DC) or more (in case of CHO) recommendations. The recommendation includes, for example, a recommended target cell/gNB ID for HO and a confidence value of the recommendation.

Since the HO recommendations are for future times, the predictions at the DT circuitry 830 might change based on updated information from sensors and measurement reports. In such cases, the DT can send changes to the previously sent recommendations by setting the recommendation type field to “update” and recommendation ID to the previous ID for which the update is being sent. The DT circuitry 830 may also cancel/revoke a previously sent recommendation by setting the recommendation type field to “revoke”.

A gNB (e.g., gNB 1320) typically uses certain criteria on the measurements reported by a UE 1310 to make HO decisions. In examples disclosed herein, the gNB 1320 additionally utilizes recommendations from the DT circuitry 830 as an additional criteria in the HO decision process. For example, the gNB 1320 can start HO preparation with the target gNB 1330 at the time as per the recommendation message from the DT circuitry 1320. Then, the source gNB 1320 may execute the HO procedure by considering measurement reports from the UE 1310 and the recommendation confidence from the DT circuitry 830.

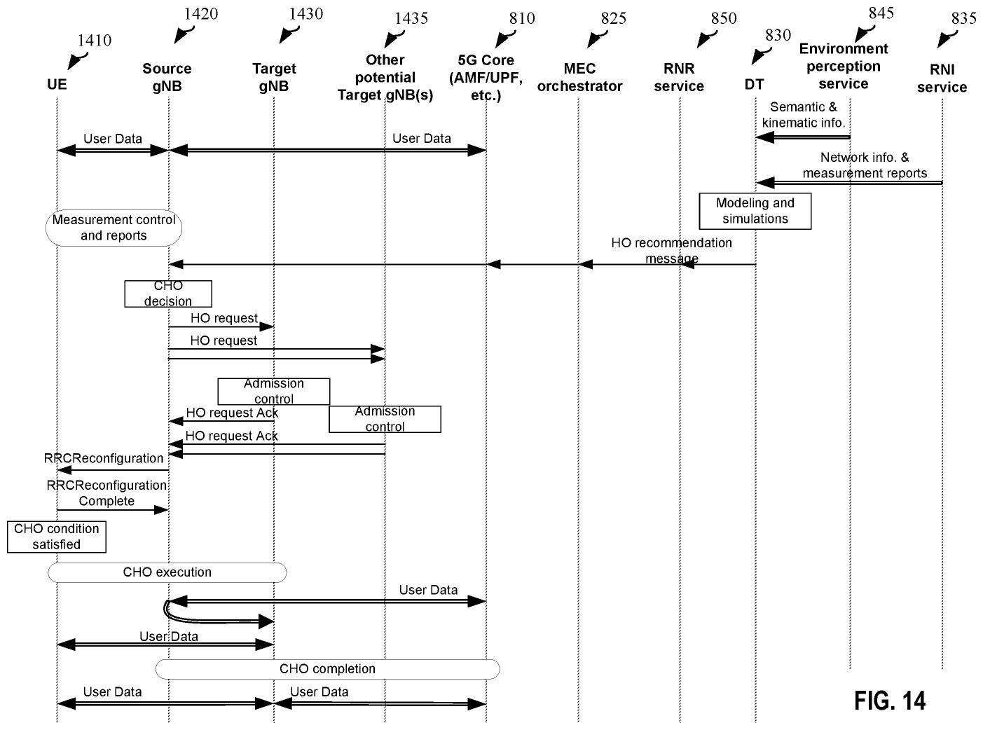

FIG. 14 is a communication diagram illustrating proactive mobility management using a conditional handover recommendation. The 3GPP has specified an enhanced mobility management procedure called conditional handover (CHO) in which a HO is executed by a UE 1410 when one or more HO execution conditions are met. In this procedure, a source gNB 1420 sends CHO configuration to the UE 1410 which contains one or more CHO target cells and execution conditions. Then, the UE 1410 continuously evaluates CHO conditions and when a condition is met, the UE 1410 executes HO (without HO command from gNB 1420) to the corresponding target cell 1430, 1435. The CHO has shown to reduce HOFs and RLFs, however, the main drawback of CHO procedure is that the source gNB 1420 needs to prepare one or more target cells 1430, 1435 for HO of a UE 1410 and reserve resources (radio resources, UE identifiers, RACH resources, etc.) in those cell(s), resulting in inefficient usage of resources. Moreover, it is possible that the UE 1410 may not perform HO to one of these target cells. Hence, the gNB 1420 needs to choose the CHO target cells carefully to minimize redundancy and improve resource usage efficiency.

In examples disclosed herein, a DT-based proactive HO procedure is disclosed in which the DT circuitry 830 aides the gNBs 1420, 1430, 1435 by providing HO related suggestions based on the predictions generated through simulations. In examples disclosed herein, the DT circuitry 830 continuously synchronizes the digital models of UEs with the semantic and kinematic information from EPS, and the measurement reports from RNI service. The DT circuitry 830 performs simulations and predicts if any UEs might require HOs in the near future. Based on the predictions of the UEs, the DT circuitry 830 sends HO recommendation messages to the respective gNBs 1420, 1430, 1435 that contain the details for gNBs to take proactive HO decisions to avoid HOFs and RLFs.

FIG. 14 shows the CHO procedure in 5G along with the proposed signaling from the DT circuitry 830 to the gNB 1420. As mentioned earlier, during CHO decision the gNB 1420 chooses the CHO target cells carefully to minimize redundancy and improve resource usage efficiency. In examples disclosed herein, the DT recommendation message contains a list of recommended target cells/gNBs which can be used by the source gNB for CHO.

In examples disclosed herein, the DT based recommendation can additionally be used to avoid ping-pongs. If the DT circuitry 830 can simulate to sufficient future time, such simulations can be used to predict if there will be ping-pong HOs for a UE (UE HO to a target cell, and after a brief time HO back to the previous serving cell). In such a case, the DT circuitry 830 may recommend dual connectivity based HO for the UE. The serving gNB 1420 can then command the UE to initiate additional connection with target cell, without dropping the connection with serving cell. Note that the UE 1410 must support such dual connectivity in order for this approach to work. The serving gNB 1410 can then drop one connection, either with serving cell or with target cell, based on certain criteria. For example, based on a pre-defined duration and/or the trends of signal strengths from serving and target cells over time. The advantage of this approach is that when a UE adds a new connection with the target cell, and after a brief time drops the connection with the target cell (ping-pong), then there will not be overhead signaling necessary to switch back to the serving cell. This is unlike the typical HO procedure which requires additional signaling overheads when a UE switches back to the serving cell from the target cell during ping-pongs.

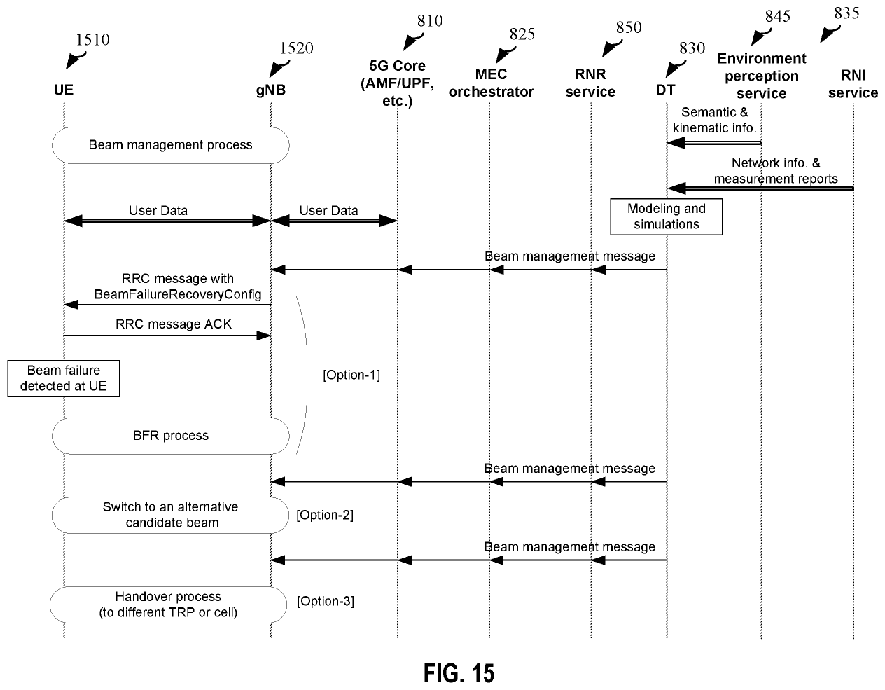

As noted above, modeling and/or simulation performed by the digital twin circuitry 830 may be used to generate recommendations for other types of systems and/or purposes. FIG. 15 is a communication diagram illustrating use of the digital twin circuitry 830 for intelligent beam management. The above-6 GHz frequency bands supported in 5G-NR are sensitive to physical blockage of radio links (when an object blocks LoS path) due to the use of highly directional transmission beams. The blockage can be due to the moving objects in communication environment (dynamic blockage), or due to the static objects intercepting the beams because of UE's mobility (geometry-induced blockage). For a UE 1510 in connected mode, the blockage may result in beam failure and cause an abrupt interruption in communication. 3GPP has defined procedure for the detection of beam failure at the UE 1510, and beam failure recovery (BFR) procedure through which the UE 1510 attempts to reestablish connection to the same cell via an alternative beam. This process can take several 10's of ms, and in some scenarios the alternative beams may also be affected resulting in further delays in beam failure recovery process due to multiple attempts, and the success is not guaranteed. Upon failure of the recovery process, the UE 1510 will be forced to initiate RLF procedure and cell reselection, which will induce significant duration of interruption in communication.

In examples disclosed herein, the DT circuitry 830 can be used to enable a robust and intelligent beam management procedure, through which the gNB 1520 can proactively reconfigure a UE to minimize BFR duration; instruct a UE to switch to an alternative beam before a blockage occurs, thereby beam failures can be avoided proactively; and/or instruct a UE to handover to a different TRP (transmission/reception point) of same cell, or handover to a different cell, before a blockage occurs to avoid potential beam failures.

The details of DT-based proactive reconfiguration of a UE to minimize BFR duration are illustrated in FIG. 15. As the DT module continuously monitors the kinematic parameters of the UEs and other objects in the communication environment, it can predict the future movements of mobile objects and UEs in the scenario, and then determine if any of the beams would potentially get blocked by the objects in near future. Based on the simulated predictions, the DT sends beam management message to the gNB which contains information about the potential blockage and the candidate beams for the BFR.

Using the information sent by the DT circuitry 830, the gNB 1520 has different options to mitigate the potential beam failure, as depicted in FIG. 15. In a first option [Option-1], the gNB 1520 sends a RRC message to the UE 1510 with a BeamFailureRecoveryConfig information element which includes a list of candidate beams for the recovery. In a second option [Option-2], the gNB 1520 sends a command to the UE 1510 (e.g., via a MAC CE, for example) to switch to an alternative candidate beam before the current beam failure occurs. In a third option [Option-3], (e.g., if there are no suitable candidate beams expected), the gNB 1520 initiates a handover of the UE 1510 to a different TRP or to a different cell before the potential beam failure.

In examples disclosed herein, the beam management message from the DT circuitry 830 to the gNB 1520 can include the following information including a list of beam management structures, each corresponding to a UE that require BFR reconfiguration in near future, and a beam recommendation structure. The beam recommendation structure can contain, for example, a Beam management message ID, a network ID of a UE, a message type (e.g., new, update, or revoke), a timestamp indicating a recommended future time at which the gNB may start HO BFR configuration, a timestamp indicating a future time before which the BFR should be completed to minimize the BFR duration, one or more candidate beams information for BFR, each including one or more of a Candidate cell and TRP IDs (in case handover is required), beam identification information, a confidence of the recommendation, etc.

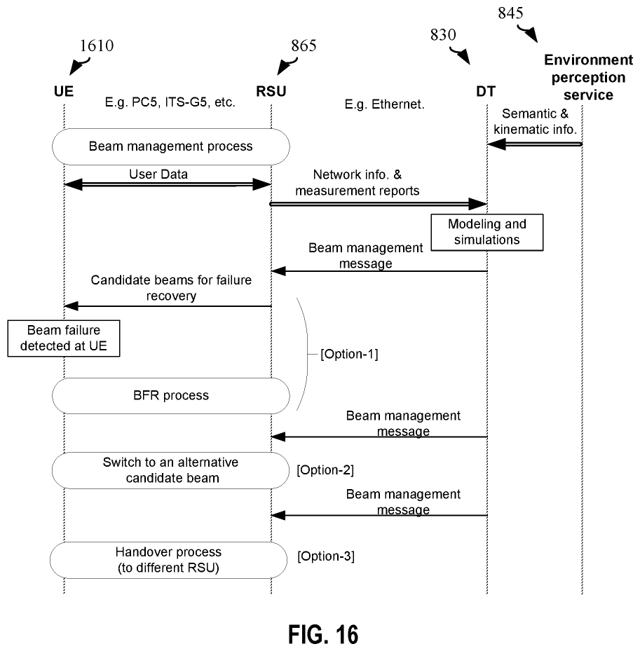

FIG. 16 is an example communication diagram 1600 illustrating the use of the digital twin circuitry 830 for beam management. Unlike the case of a gNB where the beam management messages pass through the 5G core functions (e.g., as shown in FIGS. 13, 14, and 15), in the illustrated example of FIG. 16, the beam management messages can be sent to the RSUs directly, using management plane messages. Also, the DT circuitry 830 can obtain the information of the UEs and measurement reports from RSUs via the management plane messages. Using the information sent by the DT circuitry 830, the RSU 865 has different options to mitigate the potential beam failure, as depicted in FIG. 16. In a first option [Option-1], the RSU 865 sends a message to the UE 1610 to initiate a beam failure recovery process. In a second option [Option-2], the RSU 865 sends a command to the UE 1610 to switch to an alternative candidate beam before the current beam failure occurs. In a third option [Option-3], (e.g., if there are no suitable candidate beams expected), the RSU 865 initiates a handover of the UE 1510 to a different RSU before the potential beam failure.

Application mobility is a unique feature of the MEC system 820 in which the application instance that is serving a mobile user may be relocated to different MEC hosts dynamically to keep it near the user. Such application mobility ensures that the application requirements are met in a mobile environment. Relocating an application from a source MEC host to a target MEC host typically involves creation of a new application instance at the target MEC host. If the application is a stateful application, then the newly created application instance needs to be synchronized with the original application instance by transferring its current service state (context) to the target application instance.

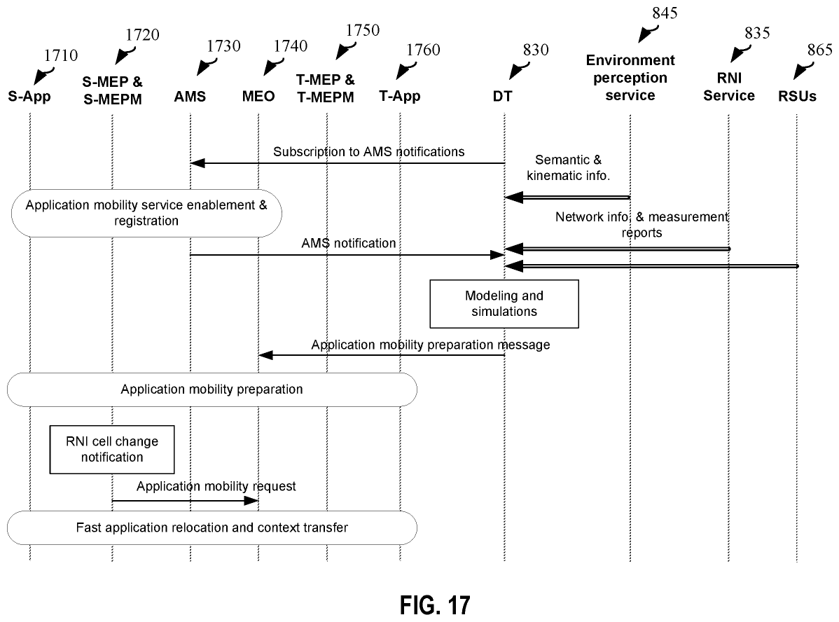

FIG. 17 is an example communication diagram illustrating the use of the digital twin circuitry for application mobility. In state-of-the-art design, the trigger for application mobility is based on the information of UE movement to a new serving cell provided by network functions. In such a design, the application mobility would always be delayed behind the user's mobility since the application relocation takes certain time duration to complete. To keep up the application mobility with the user's mobility in real time, example approaches disclosed herein utilize a DT-based application mobility initiation procedure through which the preparation for application mobility can be started ahead of a movement of a UE into the target cell.

FIG. 17 illustrates the use of an API based framework for application mobility service (AMS) 1730, in which the application relocation and context transfer (e.g., movement of an app from a source 1710 to a target 1760) can be performed via MEC platform managers (MEPMs 1720, 1750), and MEC orchestrator (MEO) 1740.

First, the DT circuitry 830 sends a message to the AMS 1730 for subscribing to the change notifications for all the UEs within its coverage. This way, the DT circuitry 830 keeps track of all the application instances associated with the UEs of interest. In some examples, the subscription to AMS notifications may instead be made by the EPS 845. When a new application is instantiated in serving MEC platform (S-MEP) 1720 of a UE, the DT circuitry 830 receives a notification from AMS about this information. As noted above, the DT circuitry 830 performs simulations and predicts if a UE might require HO in the near future. Based on these predictions and the information about the associated application instances, the DT circuitry 830 sends application mobility preparation messages to the MEC orchestrator (MEC) 1740. The application mobility preparation message can include, for example, a network ID of the UE, IDs of the associated application instances, identifiers of one or more target MEPs, etc.

After receiving the preparation message from DT circuitry 830, the MEO 1740 can execute an application mobility preparation procedure, which may include instantiating applications in one or more target MEPs and synchronizing the context information with the original application instances. However, the original application instance continues serving the UE, until the HO occurs. After the HO to a target cell, the application configured trigger mechanism initiates the application mobility request to the MEO 1740. For example, in FIG. 17, the RNI cell change notification received at S-MEP 1720 triggers the application mobility request. Then, the MEO can perform a fast application relocation and context transfer to the T-MEP 1750. Because the MEO 1740 had already instantiated the application based on the recommendation message provided by the DT circuitry 830. If the MEO 1740 had instantiated the application at multiple T-MEPs 1750, then the other application instances will to be terminated by the MEO 1740.

In the MEC system, there can be several MEC hosts/platforms, each covering a small geo-area. Hence, there can be several instances of DT application/service, each instance in a MEC host. Hence, the context of actors can be transferred between the DT instances based on the mobility of the associated users. This process is similar to the application mobility process. However, the difference is that all the users served by a MEC host can share a single DT instance in the MEC host. Hence, only the context data of actors need to be transferred to the target MEC host, if it already has DT circuitry 830 instantiated. Otherwise, the target host may need to instantiate DT circuitry 830 and then transfer the context(s) of the actors into the newly instantiated DT circuitry 830.

In some examples, the DT circuitry 830 can continuously train AI models to learn the patterns of the service demands of the users as a function of geo-area and time of the day, using information including, for example, the types of services requested by UEs, their locations, and times of the requests, etc. as received by the DT circuitry 830. Then, the DT circuitry 830 may then generate messages to pre-emptively configure the gNBs (and/or perform other mobility tasks) for spectrum resources and load balancing appropriately for different times of a day. In some examples, different gNBs can be pre-emptively configured with different transmit powers to adjust their cell sizes for appropriate load balancing between the cells based on the expected traffic and service types from the UEs, for the given time of the day. As another example, in each cell, the spectrum resources can be pre-emptively allocated to different network slices based on the expected traffic and service types from the UEs, for the given time of the day. In another example, depending on the expected traffic distribution over the geo-area during certain time of a day, some gNBs/RSUs can be pre-emptively turned OFF to improve energy efficiency of the network.

FIG. 18 is a block diagram of an example processor platform 1800 structured to execute and/or instantiate some or all of the machine readable instructions and/or operations of FIG. 11 to implement the digital twin circuitry 830 of FIG. 10. The processor platform 1800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1800 of the illustrated example includes processor circuitry 1812. The processor circuitry 1812 of the illustrated example is hardware. For example, the processor circuitry 1812 can be implemented by one or more integrated circuits, logic circuits, FPGAs microprocessors, CPUs, GPUs, DSPs, and/or microcontrollers from any desired family or manufacturer. The processor circuitry 1812 may be implemented by one or more semiconductor based (e.g., silicon based) devices. In this example, the processor circuitry 1812 implements the example information accessor circuitry 1010, the example virtual environment management circuitry 1020, the example simulation circuitry 1040, the example recommendation generator 1050, the example recommendation manager circuitry 1060, and the example recommendation provider circuitry 1070.

The processor circuitry 1812 of the illustrated example includes a local memory 1813 (e.g., a cache, registers, etc.). The processor circuitry 1812 of the illustrated example is in communication with a main memory including a volatile memory 1814 and a non-volatile memory 1816 by a bus 1818. The volatile memory 1814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1816 may be implemented by flash memory and/or any other desired type of memory device. Access to the main memory 1814, 1816 of the illustrated example is controlled by a memory controller 1817.

The processor platform 1800 of the illustrated example also includes interface circuitry 1820. The interface circuitry 1820 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1822 are connected to the interface circuitry 1820. The input device(s) 1822 permit(s) a user to enter data and/or commands into the processor circuitry 1812. The input device(s) 1822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1824 are also connected to the interface circuitry 1820 of the illustrated example. The output devices 1824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1820 of the illustrated example, thus, typically includes a graphics driver card, a graphics driver chip, and/or graphics processor circuitry such as a GPU.

The interface circuitry 1820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1800 of the illustrated example also includes one or more mass storage devices 1828 to store software and/or data. Examples of such mass storage devices 1828 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1832, which may be implemented by the machine readable instructions of FIG. 11, may be stored in the mass storage device 1828, in the volatile memory 1814, in the non-volatile memory 1816, and/or on a removable non-transitory computer readable storage medium such as a CD or DVD.

FIG. 15 is a block diagram of an example implementation of the processor circuitry 1812 of FIG. 18. In this example, the processor circuitry 1812 of FIG. 18 is implemented by a microprocessor 1900. For example, the microprocessor 1900 may implement multi-core hardware circuitry such as a CPU, a DSP, a GPU, an XPU, etc. Although it may include any number of example cores 1902 (e.g., 1 core), the microprocessor 1900 of this example is a multi-core semiconductor device including N cores. The cores 1902 of the microprocessor 1900 may operate independently or may cooperate to execute machine readable instructions. For example, machine code corresponding to a firmware program, an embedded software program, or a software program may be executed by one of the cores 1902 or may be executed by multiple ones of the cores 1902 at the same or different times. In some examples, the machine code corresponding to the firmware program, the embedded software program, or the software program is split into threads and executed in parallel by two or more of the cores 1902. The software program may correspond to a portion or all of the machine readable instructions and/or operations represented by the flowchart of FIG. 19.

The cores 1902 may communicate by an example bus 1904. In some examples, the bus 1904 may implement a communication bus to effectuate communication associated with one(s) of the cores 1902. For example, the bus 1904 may implement at least one of an Inter-Integrated Circuit (I2C) bus, a Serial Peripheral Interface (SPI) bus, a PCI bus, or a PCIe bus. Additionally or alternatively, the bus 1904 may implement any other type of computing or electrical bus. The cores 1902 may obtain data, instructions, and/or signals from one or more external devices by example interface circuitry 1906. The cores 1902 may output data, instructions, and/or signals to the one or more external devices by the interface circuitry 1906. Although the cores 1902 of this example include example local memory 1920 (e.g., Level 1 (L1) cache that may be split into an L1 data cache and an L1 instruction cache), the microprocessor 1900 also includes example shared memory 1910 that may be shared by the cores (e.g., Level 2 (L2_cache)) for high-speed access to data and/or instructions. Data and/or instructions may be transferred (e.g., shared) by writing to and/or reading from the shared memory 1910. The local memory 1920 of each of the cores 1902 and the shared memory 1910 may be part of a hierarchy of storage devices including multiple levels of cache memory and the main memory (e.g., the main memory 1814, 1816 of FIG. 18). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1902 may be referred to as a CPU, DSP, GPU, etc., or any other type of hardware circuitry. Each core 1902 includes control unit circuitry 1914, arithmetic and logic (AL) circuitry (sometimes referred to as an ALU) 1916, a plurality of registers 1918, the L1 cache 1920, and an example bus 1922. Other structures may be present. For example, each core 1902 may include vector unit circuitry, single instruction multiple data (SIMD) unit circuitry, load/store unit (LSU) circuitry, branch/jump unit circuitry, floating-point unit (FPU) circuitry, etc. The control unit circuitry 1914 includes semiconductor-based circuits structured to control (e.g., coordinate) data movement within the corresponding core 1902. The AL circuitry 1916 includes semiconductor-based circuits structured to perform one or more mathematic and/or logic operations on the data within the corresponding core 1902. The AL circuitry 1916 of some examples performs integer based operations. In other examples, the AL circuitry 1916 also performs floating point operations. In yet other examples, the AL circuitry 1916 may include first AL circuitry that performs integer based operations and second AL circuitry that performs floating point operations. In some examples, the AL circuitry 1916 may be referred to as an Arithmetic Logic Unit (ALU). The registers 1918 are semiconductor-based structures to store data and/or instructions such as results of one or more of the operations performed by the AL circuitry 1916 of the corresponding core 1902. For example, the registers 1918 may include vector register(s), SIMD register(s), general purpose register(s), flag register(s), segment register(s), machine specific register(s), instruction pointer register(s), control register(s), debug register(s), memory management register(s), machine check register(s), etc. The registers 1918 may be arranged in a bank as shown in FIG. 19. Alternatively, the registers 1918 may be organized in any other arrangement, format, or structure including distributed throughout the core 1902 to shorten access time. The bus 1920 may implement at least one of an I2C bus, a SPI bus, a PCI bus, or a PCIe bus

Each core 1902 and/or, more generally, the microprocessor 1900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 20 is a block diagram of another example implementation of the processor circuitry 1812 of FIG. 18. In this example, the processor circuitry 1812 is implemented by FPGA circuitry 2000. The FPGA circuitry 2000 can be used, for example, to perform operations that could otherwise be performed by the example microprocessor 1800 of FIG. 18 executing corresponding machine readable instructions. However, once configured, the FPGA circuitry 2000 instantiates the machine readable instructions in hardware and, thus, can often execute the operations faster than they could be performed by a general purpose microprocessor executing the corresponding software.

More specifically, in contrast to the microprocessor 1900 of FIG. 19 described above (which is a general purpose device that may be programmed to execute some or all of the machine readable instructions represented by the flowchart of FIG. 11 but whose interconnections and logic circuitry are fixed once fabricated), the FPGA circuitry 2000 of the example of FIG. 20 includes interconnections and logic circuitry that may be configured and/or interconnected in different ways after fabrication to instantiate, for example, some or all of the machine readable instructions represented by the flowchart of FIG. 11. In particular, the FPGA 2000 may be thought of as an array of logic gates, interconnections, and switches. The switches can be programmed to change how the logic gates are interconnected by the interconnections, effectively forming one or more dedicated logic circuits (unless and until the FPGA circuitry 2000 is reprogrammed). The configured logic circuits enable the logic gates to cooperate in different ways to perform different operations on data received by input circuitry. Those operations may correspond to some or all of the software represented by the flowchart of FIG. 11. As such, the FPGA circuitry 2000 may be structured to effectively instantiate some or all of the machine readable instructions of the flowchart of FIG. 11 as dedicated logic circuits to perform the operations corresponding to those software instructions in a dedicated manner analogous to an ASIC. Therefore, the FPGA circuitry 2000 may perform the operations corresponding to the some or all of the machine readable instructions of FIG. 11 faster than the general purpose microprocessor can execute the same.

In the example of FIG. 20, the FPGA circuitry 2000 is structured to be programmed (and/or reprogrammed one or more times) by an end user by a hardware description language (HDL) such as Verilog. The FPGA circuitry 2000 of FIG. 20, includes example input/output (I/O) circuitry 2002 to obtain and/or output data to/from example configuration circuitry 2004 and/or external hardware (e.g., external hardware circuitry) 2006. For example, the configuration circuitry 2004 may implement interface circuitry that may obtain machine readable instructions to configure the FPGA circuitry 2000, or portion(s) thereof. In some such examples, the configuration circuitry 2004 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 2006 may implement the microprocessor 1900 of FIG. 9. The FPGA circuitry 2000 also includes an array of example logic gate circuitry 2008, a plurality of example configurable interconnections 2010, and example storage circuitry 2012. The logic gate circuitry 2008 and interconnections 2010 are configurable to instantiate one or more operations that may correspond to at least some of the machine readable instructions of FIG. 11 and/or other desired operations. The logic gate circuitry 2008 shown in FIG. 20 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2008 to enable configuration of the electrical structures and/or the logic gates to form circuits to perform desired operations. The logic gate circuitry 2008 may include other electrical structures such as look-up tables (LUTs), registers (e.g., flip-flops or latches), multiplexers, etc.

The interconnections 2010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2008 to program desired logic circuits.

The storage circuitry 2012 of the illustrated example is structured to store result(s) of the one or more of the operations performed by corresponding logic gates. The storage circuitry 2012 may be implemented by registers or the like. In the illustrated example, the storage circuitry 2012 is distributed amongst the logic gate circuitry 2008 to facilitate access and increase execution speed.

The example FPGA circuitry 2000 of FIG. 20 also includes example Dedicated Operations Circuitry 2014. In this example, the Dedicated Operations Circuitry 2014 includes special purpose circuitry 2016 that may be invoked to implement commonly used functions to avoid the need to program those functions in the field. Examples of such special purpose circuitry 2016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2000 may also include example general purpose programmable circuitry 2018 such as an example CPU 2020 and/or an example DSP 2022. Other general purpose programmable circuitry 2018 may additionally or alternatively be present such as a GPU, an XPU, etc., that can be programmed to perform other operations.

Although FIGS. 19 and 20 illustrate two example implementations of the processor circuitry 1812 of FIG. 18, many other approaches are contemplated. For example, as mentioned above, modern FPGA circuitry may include an on-board CPU, such as one or more of the example CPU 2020 of FIG. 20. Therefore, the processor circuitry 1812 of FIG. 18 may additionally be implemented by combining the example microprocessor 1900 of FIG. 19 and the example FPGA circuitry 2000 of FIG. 20. In some such hybrid examples, a first portion of the machine readable instructions represented by the flowchart of FIG. 1 may be executed by one or more of the cores 1902 of FIG. 19 and a second portion of the machine readable instructions represented by the flowchart of FIG. 11 may be executed by the FPGA circuitry 2000 of FIG. 20.

In some examples, the processor circuitry 1812 of FIG. 18 may be in one or more packages. For example, the processor circuitry 500 of FIG. 5 and/or the FPGA circuitry _00 of FIG. 5 may be in one or more packages. In some examples, an XPU may be implemented by the processor circuitry 1812 of FIG. 18, which may be in one or more packages. For example, the XPU may include a CPU in one package, a DSP in another package, a GPU in yet another package, and an FPGA in still yet another package.

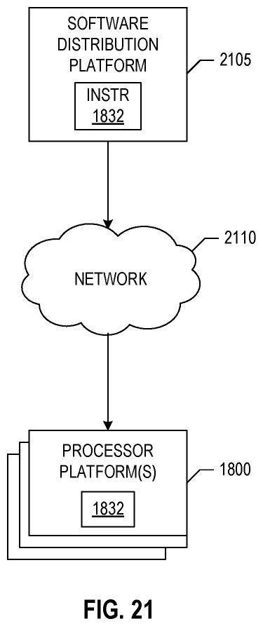

A block diagram illustrating an example software distribution platform 1805 to distribute software such as the example machine readable instructions 1832 of FIG. 18 to hardware devices owned and/or operated by third parties is illustrated in FIG. 21. The example software distribution platform 2105 may be implemented by any computer server, data facility, cloud service, etc., capable of storing and transmitting software to other computing devices. The third parties may be customers of the entity owning and/or operating the software distribution platform 2105. For example, the entity that owns and/or operates the software distribution platform 2105 may be a developer, a seller, and/or a licensor of software such as the example machine readable instructions 1832 of FIG. 18. The third parties may be consumers, users, retailers, OEMs, etc., who purchase and/or license the software for use and/or re-sale and/or sub-licensing. In the illustrated example, the software distribution platform 2105 includes one or more servers and one or more storage devices. The storage devices store the machine readable instructions 1832, which may correspond to the example machine readable instructions of FIG. 11, as described above. The one or more servers of the example software distribution platform 2105 are in communication with a network 2110, which may correspond to any one or more of the Internet and/or any of the example networks 1826 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1832 from the software distribution platform 2105. For example, the software, which may correspond to the example machine readable instructions FIG. 11, may be downloaded to the example processor platform 1800, which is to execute the machine readable instructions 1832 to implement the digital twin circuitry 830. In some example, one or more servers of the software distribution platform 2105 periodically offer, transmit, and/or force updates to the software (e.g., the example machine readable instructions 1832 of FIG. 18) to ensure improvements, patches, updates, etc., are distributed and applied to the software at the end user devices.

From the foregoing, it will be appreciated that example systems, methods, apparatus, and articles of manufacture have been disclosed that enable a digital twin to be utilized to enhance resiliency and/or reliability of a communications network. The disclosed systems, methods, apparatus, and articles of manufacture improve the efficiency of using a computing device by ensuring that networks with which such computing devices communicate are more robust. The disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for digital twin aided resiliency are disclosed herein. Further examples and combinations thereof include the following:

Example 1 includes an apparatus for digital twin aided resiliency, the apparatus comprising interface circuitry, processor circuitry including one or more of at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrated Circuitry (ASIC) including logic gate circuitry to perform one or more third operations, the processor circuitry to perform at least one of the first operations, the second operations or the third operations to instantiate information accessor circuitry to access operational statistics corresponding to one or more physical entities, the one or more physical entities including user equipment and network equipment, virtual environment management circuitry to update one or more virtual entities within a virtual environment that correspond, respectively, to the one or more physical entities with the operational statistics, simulation circuitry to simulate a change to the virtual environment based on the operational statistics, the simulated change to the virtual environment representing a future state, recommendation generator circuitry to generate a recommendation for the network equipment to perform a task based on the simulated change, and recommendation provider circuitry to, in response to determining at least one of a confidence of the recommendation meets a threshold confidence or a predefined condition is met, provide the recommendation to the network equipment.

Example 2 includes the apparatus of example 1, wherein the operational statistics correspond to semantic and kinematic information of the one or more physical entities.

Example 3 includes the apparatus of example 1, wherein the operational statistics correspond to network information and measurement reports of the one or more physical entities.

Example 4 includes the apparatus of example 3, wherein the operational statistics correspond to local environment conditions.

Example 5 includes the apparatus of example 4, wherein the local environment conditions include a local weather condition.

Example 6 includes the apparatus of example 1, wherein the network equipment is a roadside unit (RSU), and the recommendation for the network equipment to perform the task is a recommendation to mitigate a potential beam failure.

Example 7 includes the apparatus of example 1, wherein the processor circuitry is to perform at least one of the first operations, the second operations or the third operations to instantiate a recommendation service to convey the recommendation to a 5G network.

Example 8 includes the apparatus of example 1, wherein the recommendation for the network equipment to perform the task is a recommendation for the network equipment to perform a handover.

Example 9 includes the apparatus of example 8, wherein the recommendation provider circuitry is to provide the recommendation for the network equipment to perform the handover to the network equipment prior to the user equipment requesting the handover.

Example 10 includes the apparatus of example 8, wherein the handover is a conditional handover.

Example 11 includes the apparatus of example 1, wherein the recommendation for the network equipment to perform the task is a recommendation for the network equipment to perform beam failure recovery.

Example 12 includes the apparatus of example 11, wherein the beam failure recovery is a proactive beam failure recovery.

Example 13 includes the apparatus of example 1, wherein the recommendation for the network equipment to perform the task is a recommendation for the network equipment to perform an application mobility preparation procedure.

Example 14 includes the apparatus of example 1, wherein the recommendation for the network equipment to perform the task is a recommendation for the network equipment to utilize dual connectivity to avoid a ping pong effect.

Example 15 includes the apparatus of example 1, wherein the recommendation for the network equipment to perform the task is a recommendation for the network equipment to initiate a new connection with a target cell, without dropping an existing connection with a serving cell.

Example 16 includes at least one non-transitory computer readable medium comprising instructions that, when executed, cause at least one processor to at least access operational statistics corresponding to one or more physical entities, the one or more physical entities including user equipment and network equipment, update one or more virtual entities within a virtual environment that correspond, respectively, to the one or more physical entities with the operational statistics, simulate a change to the virtual environment based on the operational statistics, the simulated change to the virtual environment representing a future state, generate a recommendation for the network equipment to perform a task based on the simulated change, and in response to determining a confidence of the recommendation meets a threshold confidence, provide the recommendation to the network equipment.

Example 17 includes the at least one non-transitory computer readable medium of example 16, wherein the operational statistics correspond to semantic and kinematic information of the one or more physical entities.

Example 18 includes the at least one non-transitory computer readable medium of example of example 16, wherein the operational statistic corresponds to a network information and measurement report of the one or more physical entities.

Example 19 includes the at least one non-transitory computer readable medium of example 18, wherein the operational statistics correspond to local environment conditions.

Example 20 includes the at least one non-transitory computer readable medium of example 19, wherein the local environment conditions include a local weather condition.

Example 21 includes the at least one non-transitory computer readable medium of example 16, wherein the network equipment is a roadside unit (RSU), and the recommendation for the network equipment to perform the task is a recommendation to mitigate a potential beam failure.

Example 22 includes the at least one non-transitory computer readable medium of example 16, wherein the instructions, when executed, further cause the at least one processor to execute a recommendation service to convey the recommendation to a 5G network.

Example 23 includes the at least one non-transitory computer readable medium of example of example 16, wherein the recommendation for the network equipment to perform the task is a recommendation for the network equipment to perform a handover.

Example 24 includes the at least one non-transitory computer readable medium of example of example 23, wherein the recommendation for the network equipment to perform the handover is provided to the network equipment prior to the user equipment requesting the handover.

Example 25 includes the at least one non-transitory computer readable medium of example of example 23, wherein handover is a conditional handover.

Example 26 includes the at least one non-transitory computer readable medium of example of example 16, wherein the recommendation for the network equipment to perform the task is a recommendation for the network equipment to perform beam failure recovery.

Example 27 includes the at least one non-transitory computer readable medium of example 26, wherein the beam failure recovery is a preemptive beam failure recovery.

Example 28 includes the at least one non-transitory computer readable medium of example 16, wherein the recommendation for the network equipment to perform the task is a recommendation for the network equipment to perform an application mobility preparation procedure.

Example 29 includes the at least one non-transitory computer readable medium of example 16, wherein the recommendation for the network equipment to perform the task is a recommendation for the network equipment to utilize dual connectivity to avoid a ping pong effect.

Example 30 includes the at least one non-transitory computer readable medium of example 16, wherein the recommendation for the network equipment to perform the task is a recommendation for the network equipment to initiate a new connection with a target cell, without dropping an existing connection with a serving cell.

Example 31 includes an apparatus for digital twin aided resiliency, the apparatus comprising means for accessing operational statistics corresponding to one or more physical entities, the one or more physical entities including user equipment and network equipment, means for updating one or more virtual entities within a virtual environment that correspond, respectively, to the one or more physical entities with the operational statistics, means for simulating a change to the virtual environment based on the operational statistics, the simulated change the virtual environment representing a figure state, means for generating a recommendation for the network equipment to perform a task based on the simulated change, and means for providing, in response to determining a confidence of the recommendation meets a threshold confidence, the recommendation to the network equipment.

Example 32 includes the apparatus of example 31, wherein the operational statistics correspond to semantic and kinematic information of the one or more physical entities.

Example 33 includes the apparatus of example 31, wherein the operational statistics correspond to network information and measurement reports of the one or more physical entities.

Example 34 includes the apparatus of example 33, wherein the operational statistics correspond to local environment conditions.

Example 35 includes the apparatus of example 34, wherein the local environment conditions include a local weather condition.

Example 36 includes the apparatus of example 31, wherein the network equipment is a roadside unit (RSU), and the recommendation for the network equipment to perform the task is a recommendation to mitigate a potential beam failure.

Example 37 includes the apparatus of example 31, further including means for conveying the recommendation to a 5G network.

Example 38 includes the apparatus of example 31, wherein the recommendation for the network equipment to perform the task is a recommendation for the network equipment to perform a handover.

Example 39 includes the apparatus of example 38, wherein the recommendation for the network equipment to perform the handover is provided to the network equipment prior to the user equipment requesting the handover.

Example 40 includes the apparatus of example 38, wherein the handover is a conditional handover.

Example 41 includes the apparatus of example 31, wherein the recommendation for the network equipment to perform the task is a recommendation for the network equipment to perform beam failure recovery.

Example 42 includes the apparatus of example 41, wherein the beam failure recovery is a proactive beam failure recovery.

Example 43 includes the apparatus of example 31, wherein the recommendation for the network equipment to perform the task is a recommendation for the network equipment to perform an application mobility preparation procedure.

Example 44 includes the apparatus of example 31, wherein the recommendation for the network equipment to perform the task is a recommendation for the network equipment to utilize dual connectivity to avoid a ping pong effect.

Example 45 includes the apparatus of example 31, wherein the recommendation for the network equipment to perform the task is a recommendation for the network equipment to initiate a new connection with a target cell, without dropping an existing connection with a serving cell.

Example 46 includes a method for digital twin aided resiliency, the method comprising accessing operational statistics corresponding to one or more physical entities, the one or more physical entities including user equipment and network equipment, updating one or more virtual entities within a virtual environment that correspond, respectively, to the one or more physical entities with the operational statistics, simulating a change to the virtual environment based on the operational statistics, the simulated change to the virtual environment representing a future state, generating a recommendation for the network equipment to perform a task based on the simulated change, and in response to determining a confidence of the recommendation meets a threshold confidence, provide the recommendation to the network equipment.

Example 47 includes the method of example 46, wherein the operational statistics correspond to semantic and kinematic information of the one or more physical entities.

Example 48 includes the method of example 46, wherein the operational statistics correspond to network information and measurement reports of the one or more physical entities.

Example 49 includes the method of example 48, wherein the operational statistics correspond to local environment conditions.

Example 50 includes the method of example 49, wherein the local environment conditions include a local weather condition.

Example 51 includes the method of example 46, wherein the network equipment is a roadside unit (RSU), and the recommendation for the network equipment to perform the task is a recommendation to mitigate a potential beam failure.

Example 52 includes the method of example 46, wherein the instructions, when executed, further cause the at least one processor to execute a recommendation service to convey the recommendation to a 5G network.

Example 53 includes the method of example 46, wherein the recommendation for the network equipment to perform the task is a recommendation for the network equipment to perform a handover.

Example 54 includes the method of example 53, wherein the recommendation for the network equipment to perform the handover is provided to the network equipment prior to the user equipment requesting the handover.

Example 55 includes the method of example 53, wherein the handover is a conditional handover.

Example 56 includes the method of example 46, wherein the recommendation for the network equipment to perform the task is a recommendation for the network equipment to perform beam failure recovery.

Example 57 includes the method of example 56, wherein the beam failure recovery is a preemptive beam failure recovery.

Example 58 includes the method of example 46, wherein the recommendation for the network equipment to perform the task is a recommendation for the network equipment to perform an application mobility preparation procedure.

Example 59 includes the method of example 46, wherein the recommendation for the network equipment to perform the task is a recommendation for the network equipment to utilize dual connectivity to avoid a ping pong effect.

Example 60 includes the method of example 46, wherein the recommendation for the network equipment to perform the task is a recommendation for the network equipment to initiate a new connection with a target cell, without dropping an existing connection with a serving cell.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus for digital twin aided resiliency, the apparatus comprising:
interface circuitry;
processor circuitry including one or more of:
at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
Application Specific Integrated Circuitry (ASIC) including logic gate circuitry to perform one or more third operations;
the processor circuitry to perform at least one of the first operations, the second operations or the third operations to instantiate:
information accessor circuitry to access operational statistics corresponding to one or more physical entities, the one or more physical entities including user equipment and network equipment;
virtual environment management circuitry to update one or more virtual entities within a virtual environment that correspond, respectively, to the one or more physical entities with the operational statistics;
simulation circuitry to simulate a change to the virtual environment based on the operational statistics, the simulated change to the virtual environment representing a future state;
recommendation generator circuitry to generate a recommendation for the network equipment to perform a task based on the simulated change; and
recommendation provider circuitry to, in response to determining at least one of a confidence of the recommendation meets a threshold confidence or a predefined condition is met, provide the recommendation to the network equipment.

2. The apparatus of claim 1, wherein the operational statistics correspond to semantic and kinematic information of the one or more physical entities.

3. The apparatus of claim 1, wherein the operational statistics correspond to network information and measurement reports of the one or more physical entities.

4. The apparatus of claim 3, wherein the operational statistics correspond to local environment conditions.

5. The apparatus of claim 4, wherein the local environment conditions include a local weather condition.

6. The apparatus of claim 1, wherein the network equipment is a roadside unit (RSU), and the recommendation for the network equipment to perform the task is a recommendation to mitigate a potential beam failure.

7. The apparatus of claim 1, wherein the processor circuitry is to perform at least one of the first operations, the second operations or the third operations to instantiate a recommendation service to convey the recommendation to a 5G network.

8. The apparatus of claim 1, wherein the recommendation for the network equipment to perform the task is a recommendation for the network equipment to perform a handover.

9. The apparatus of claim 8, wherein the recommendation provider circuitry is to provide the recommendation for the network equipment to perform the handover to the network equipment prior to the user equipment requesting the handover.

10. The apparatus of claim 8, wherein the handover is a conditional handover.

11. The apparatus of claim 1, wherein the recommendation for the network equipment to perform the task is a recommendation for the network equipment to perform beam failure recovery.

12. The apparatus of claim 11, wherein the beam failure recovery is a proactive beam failure recovery.

13. The apparatus of claim 1, wherein the recommendation for the network equipment to perform the task is a recommendation for the network equipment to perform an application mobility preparation procedure.

14. The apparatus of claim 1, wherein the recommendation for the network equipment to perform the task is a recommendation for the network equipment to utilize dual connectivity to avoid a ping pong effect.

15. The apparatus of claim 1, wherein the recommendation for the network equipment to perform the task is a recommendation for the network equipment to initiate a new connection with a target cell, without dropping an existing connection with a serving cell.

16. At least one non-transitory computer readable medium comprising instructions that, when executed, cause at least one processor to at least:
access operational statistics corresponding to one or more physical entities, the one or more physical entities including user equipment and network equipment;
update one or more virtual entities within a virtual environment that correspond, respectively, to the one or more physical entities with the operational statistics;
simulate a change to the virtual environment based on the operational statistics, the simulated change to the virtual environment representing a future state;
generate a recommendation for the network equipment to perform a task based on the simulated change; and
in response to determining a confidence of the recommendation meets a threshold confidence, provide the recommendation to the network equipment.

17. The at least one non-transitory computer readable medium of claim 16, wherein the operational statistics correspond to semantic and kinematic information of the one or more physical entities.

18. The at least one non-transitory computer readable medium of claim of claim 16, wherein the operational statistic corresponds to a network information and measurement report of the one or more physical entities.

19. The at least one non-transitory computer readable medium of claim 18, wherein the operational statistics correspond to local environment conditions.

20. The at least one non-transitory computer readable medium of claim 19, wherein the local environment conditions include a local weather condition.

21. The at least one non-transitory computer readable medium of claim 16, wherein the network equipment is a roadside unit (RSU), and the recommendation for the network equipment to perform the task is a recommendation to mitigate a potential beam failure.

22. The at least one non-transitory computer readable medium of claim 16, wherein the instructions, when executed, further cause the at least one processor to execute a recommendation service to convey the recommendation to a 5G network.

23. The at least one non-transitory computer readable medium of claim of claim 16, wherein the recommendation for the network equipment to perform the task is a recommendation for the network equipment to perform a handover.

24-30. (canceled)

31. An apparatus for digital twin aided resiliency, the apparatus comprising:
means for accessing operational statistics corresponding to one or more physical entities, the one or more physical entities including user equipment and network equipment;
means for updating one or more virtual entities within a virtual environment that correspond, respectively, to the one or more physical entities with the operational statistics;
means for simulating a change to the virtual environment based on the operational statistics, the simulated change the virtual environment representing a figure state;
means for generating a recommendation for the network equipment to perform a task based on the simulated change; and
means for providing, in response to determining a confidence of the recommendation meets a threshold confidence, the recommendation to the network equipment.

32-45. (canceled)

46. A method for digital twin aided resiliency, the method comprising:
accessing operational statistics corresponding to one or more physical entities, the one or more physical entities including user equipment and network equipment;
updating one or more virtual entities within a virtual environment that correspond, respectively, to the one or more physical entities with the operational statistics;
simulating a change to the virtual environment based on the operational statistics, the simulated change to the virtual environment representing a future state;
generating a recommendation for the network equipment to perform a task based on the simulated change; and
in response to determining a confidence of the recommendation meets a threshold confidence, provide the recommendation to the network equipment.

47-60. (canceled)
